(19) United States
(12) Patent Application Publication
(10) Pub. No.: US 2014/0125711 A1
(43) Pub. Date: May 8, 2014

(54) DISPLAY DEVICE

(71) Applicant: Panasonic Liquid Crystal Display Co., Ltd,, Hyogo (JP)

(72) Inventors: Toshiki Onishi, Osaka (JP); Hideyuki Nakanishi, Osaka (JP); Takahiro Kobayashi, Okayama (JP)

(73) Assignee: PANASONIC LIQUID CRYSTAL DISPLAY CO., LTD,, Hyogo (JP)

(21) Appl. No.: 14/122,205

(22) PCT Filed: May 21, 2012
(86) PCT No.: PCT/JP2012/003301

§ 371 Date: Nov. 25, 2013

(30) Foreign Application Priority Data
May 31, 2011 (JP) 2011-121860
May 31, 2011 (JP) 2011-121861

(51) Int. Cl. G09G 3/36; G09G 3/34

(52) U.S. Cl. CPC G09G 3/3607; G09G 3/3406
USPC 345/690; 345/102

(57) ABSTRACT

A display device includes a display portion having an emitting portion, a brightness distribution storage storing brightness distribution information indicating emission brightness distribution of the display portion and target brightness distribution thereof, a first feature amount calculator calculating a first feature amount of the image for judging an allowable corrective increase amount, from a video signal for plural pixels, and a brightness increase processor making corrective increase for the display brightness of the pixels based on the brightness distribution information and the first feature amount. The brightness increase processor judges the allowable corrective increase amount of the display brightness of each of the pixels based on the first feature amount, and makes corrective increase for the display brightness of the pixels corresponding to a low brightness area where the emission brightness distribution of the display portion is lower than the target brightness distribution, based on the allowable corrective increase amount.

### TECHNICAL FIELD

The present invention relates to a display device that displays images.

### BACKGROUND ART

A display device that uses liquid crystals as an optical modulator includes a backlight that illuminates a liquid crystal panel from a rear face, and displays an arbitrary image on the liquid crystal panel by controlling transmittance of light emitted from the backlight by the liquid crystals. Conventionally unevenness of brightness on the liquid crystal panel may appear due to backlight that illuminates the liquid crystal panel from the rear face. Therefore techniques to correct unevenness of brightness by correcting the video signal have been proposed (e.g. see Patent Document 1). According to the technique disclosed in Patent Document 1, gamma correction is performed according to a signal level and a position of input video signals over the entire display screen upon correcting the video signal.

However according to the technique disclosed in Patent Document 1, the correction is performed regardless the input video signal. Therefore, the input video signal may cause problems, such as insufficiently corrected brightness, or reduced quality of the displayed image even under correction to the brightness.

Patent Document 1: Japanese Patent Application Laid-Open No. 2008-145471

### SUMMARY OF INVENTION

With the foregoing in view, it is an object of the invention to provide a display device that may prevent from degrading quality of a displayed image by appropriately correcting brightness in response to the input video signal.

According to an aspect of the present disclosure, a display device comprising: a display portion which includes an emitting portion having one or plural light sources emitting light, and uses light emitted from the one or plural light sources of the emitting portion to display an image corresponding to a video signal including display brightness data that is set for each of plural pixels; a brightness distribution storage that stores brightness distribution information indicating emission brightness distribution of the display portion and predetermined target brightness distribution of the display portion; a first feature amount calculator that calculates a first feature amount of the image for judging an allowable corrective increase amount from the video signal for the plural pixels, the allowable corrective increase amount being an amount within which the display brightness data is subjected to corrective increase without deteriorating the image; a brightness increase processor that makes corrective increase for the display brightness data of the pixels, based on the brightness distribution information stored in the brightness distribution storage and the first feature amount calculated by the first feature amount calculator, wherein the brightness increase processor judges the allowable corrective increase amount of the display brightness of each of the pixels based on the first feature amount calculated by the first feature amount calculator, and makes corrective increase for the display brightness data of the pixels corresponding to a low brightness area where the emission brightness distribution of the display portion is lower than the target brightness distribution, based on the allowable corrective increase amount.

According to another aspect of the present disclosure, a display device comprising: a display portion that includes an emitting portion having one or plural light sources emitting light, and uses light emitted from the one or plural light sources of the emitting portion to display an image corresponding to a video signal including display brightness data which is set for each of plural pixels; a brightness distribution storage that stores brightness distribution information indicating emission brightness distribution of the display portion and predetermined target brightness distribution of the display portion; a feature amount calculator that calculates a feature amount of the image for judging a required corrective suppression amount from the video signal for the plural pixels, the required corrective suppression amount indicating a degree how much the display brightness of the pixels is required for corrective suppression; and a brightness suppressing processor that makes corrective suppression for the display brightness data of the pixels, based on the brightness distribution information stored in the brightness distribution storage and the feature amount calculated by the feature amount calculator, wherein the target brightness distribution is set so as to include an area having lower brightness values than emission brightness distribution of the emitting portion, and the brightness suppressing processor judges the required corrective suppression amount of the display brightness of each of the pixels, based on the feature amount calculated by the feature amount calculator, and makes corrective suppression for the display brightness data of the pixels corresponding to a high brightness area where the emission brightness distribution of the display portion is higher than the target brightness distribution, based on the required corrective suppression amount.

According to another aspect of the present disclosure, a display device comprising: a display portion that includes an emitting portion having one or plural light sources emitting light, and uses light emitted from the one or plural light sources of the emitting portion to display an image corresponding to a video signal including display brightness data which is set for each of plural pixels; a brightness distribution storage that stores brightness distribution information indicating emission brightness distribution of the display portion and desired target brightness distribution of the display portion; a feature amount calculator that calculates a feature amount of the image for judging a required corrective increase amount from the video signal for the plural pixels, the required corrective increase amount indicating a degree how much the display brightness of the pixels is required for corrective increase; and a brightness increase processor that makes corrective increase for the display brightness data of the pixels, based on the brightness distribution information stored in the brightness distribution storage and the feature amount calculated by the feature amount calculator, wherein the target brightness distribution is set so as to include an area having higher brightness values than emission brightness distribution of the emitting portion, and the brightness increase processor judges the required corrective increase amount of the display brightness of each of the pixels, based on the feature amount calculated by the feature amount calculator, and makes corrective increase for the display brightness data of the pixels corresponding to a low brightness area where the emission brightness distribution of the display portion is lower than the target brightness distribution, based on the required corrective increase amount.

According to the present invention, a high quality image may be displayed in a great variety of scenes without generating side effects, by performing optimum brightness correction depending on the image.

### BRIEF DESCRIPTION OF DRAWINGS

FIG. 1 is a block diagram depicting a configuration of a liquid crystal display device according to the first embodiment of the present invention.

FIG. 2 is a block diagram depicting a configuration of a video signal processor in FIG. 1.

FIG. 3 is a schematic diagram depicting an example of current brightness distribution.

FIGS. 4A and 4B are schematic diagrams depicting examples of target brightness distribution.

FIG. 5 is a schematic diagram depicting a liquid crystal panel of which display screen is virtually divided into 4×4 divided areas.

FIG. 6 is a schematic diagram depicting an example of a weakly increasing function.

FIG. 7 is a block diagram depicting a configuration of a video signal processor that is disposed in a liquid crystal display device according to the second embodiment of the present invention.

FIG. 8 is a schematic diagram depicting an example of an analysis result by a frequency analyzer.

FIGS. 9A and 9B are schematic diagrams depicting brightness histograms generated by a flatness analyzer.

FIGS. 10A and 10B are schematic diagrams depicting an example of the second target brightness distribution used for brightness corrective suppression.

FIGS. 11A and 11B are schematic diagrams depicting another example of the second target brightness distribution used for brightness corrective suppression.

FIG. 12 is a block diagram depicting a configuration of a liquid crystal display device according to the third embodiment of the present invention.

FIG. 13 is a block diagram depicting a configuration of a video signal processor illustrated in FIG. 12.

FIG. 14 is a block diagram depicting a configuration of a video signal processor disposed in a liquid crystal display device according to the fourth embodiment of the present invention.

FIGS. 15A and 15B are schematic diagrams depicting examples of target brightness distribution used for brightness corrective suppression.

### DESCRIPTION OF EMBODIMENTS

### First Embodiment

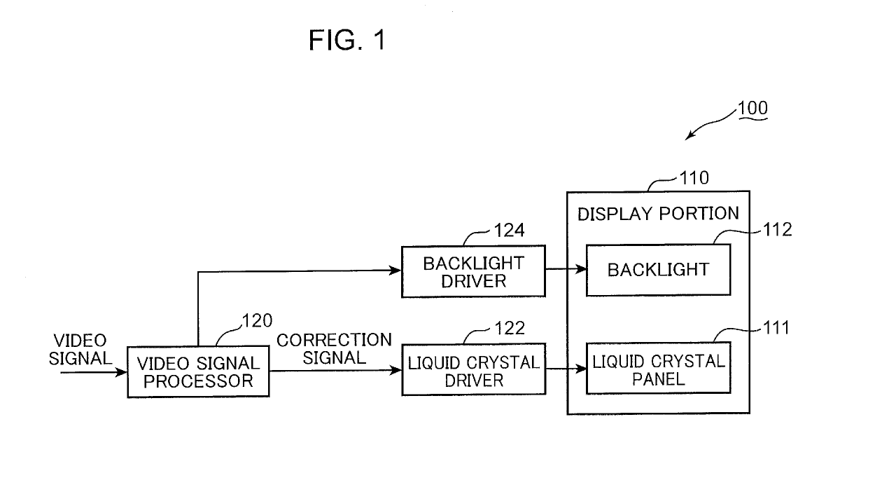

FIG. 1 is a block diagram depicting a configuration of a liquid crystal display device according to the first embodiment of the present invention. A liquid crystal display device 100 illustrated in FIG. 1 includes a display portion 110, a video signal processor 120, a liquid crystal driver 122 and a backlight driver 124. The display portion 110 includes a liquid crystal panel 111 and a backlight 112.

The video signal processor 120 generates a correction signal by correcting a video signal to be input, and outputs the generated correction signal to the liquid crystal driver 122. The video signal processor 120 outputs a control signal to the backlight driver 124 and turns the backlight 112 on. The video signal processor 120 will be described later.

The liquid crystal panel 111 includes scanning lines which extend in the horizontal direction, signal lines which extend in the vertical direction, a switching element and pixels, which are not illustrated. The pixels are disposed in a matrix at the intersection points of the signal lines and the scanning lines, and one scanning line is constituted by a line of pixels arrayed in the horizontal direction. The liquid crystal driver 122 supplies pixel signals to the signal lines based on correction signals from the video signal processor 120, and supplies gate pulses, which constitute scanning signals, to the scanning lines. The liquid crystal driver 122 applies a signal voltage to a liquid crystal layer corresponding to each of the pixels, and controls transmittance of the liquid crystals. For the liquid crystal panel 111, an IPS (In Plane Switching) system, a VA (Vertical Alignment) system and any other system may be applied.

The backlight 112 emits light with a predetermined brightness distribution to illuminate the liquid crystal panel 111 from the rear face, so as to display an image on the liquid crystal panel 111. The backlight 112 has a light source, such as a cold cathode fluorescent lamp. The backlight driver 124 drives the backlight 112 based on the control signal from the video signal processor 120. A light guiding plate to guide the light from the backlight 112 to the liquid crystal panel 111 or a diffuser to diffuse the light from the backlight 112 and guide the diffused light to the liquid crystal panel 111 may be disposed between the liquid crystal panel 111 and the backlight 112.

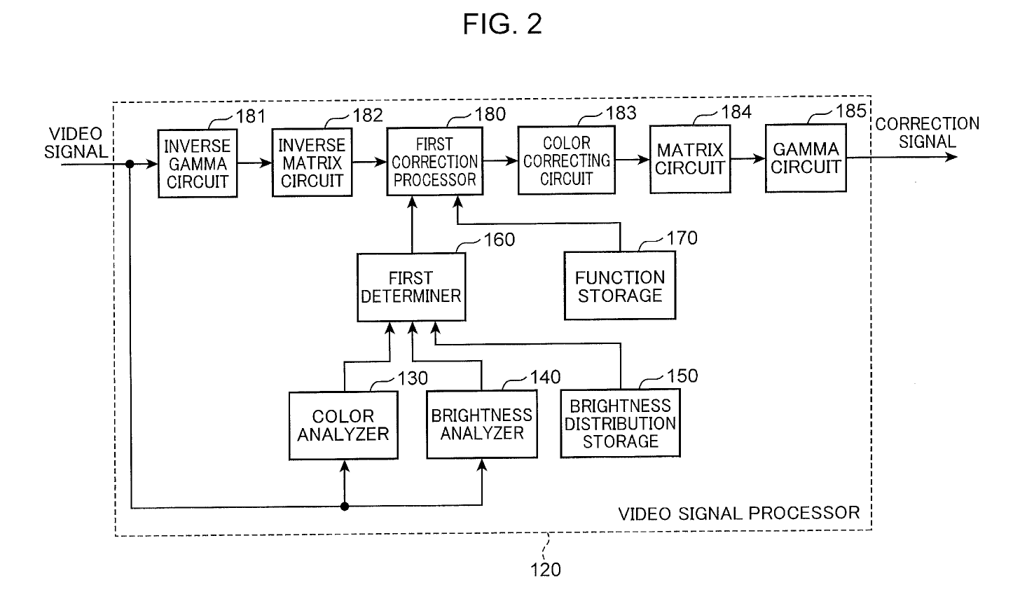

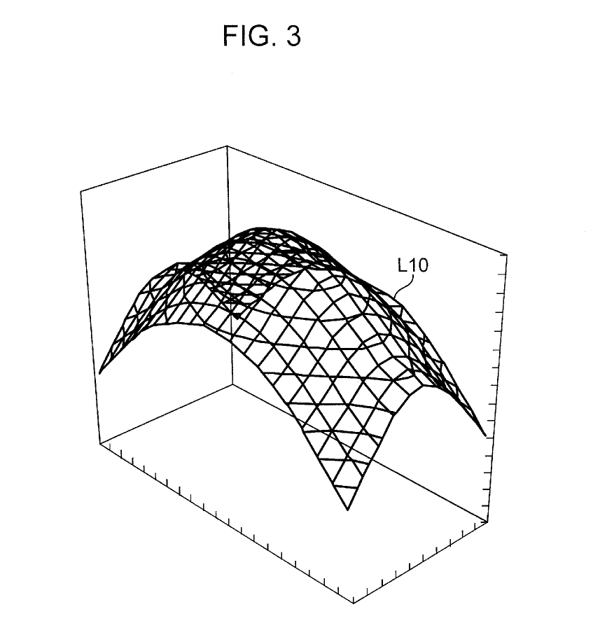

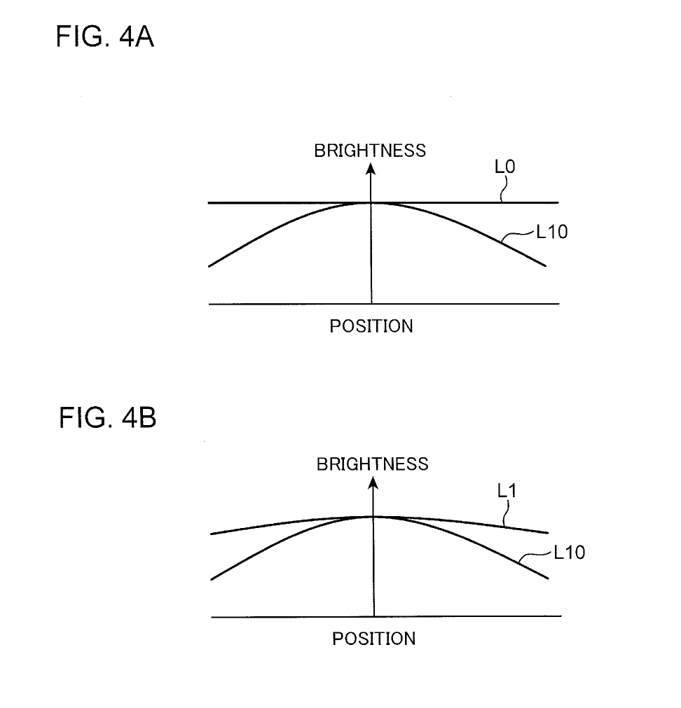

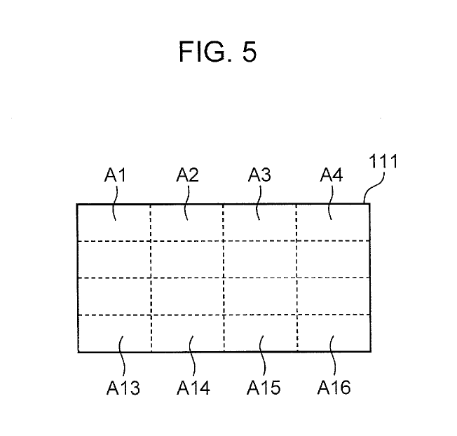

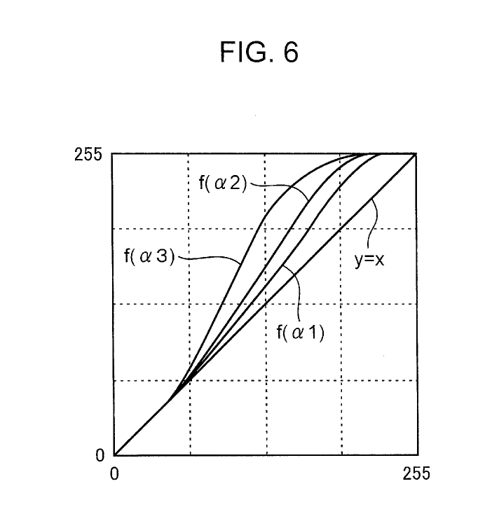

FIG. 2 is a block diagram depicting a configuration of the video signal processor 120 illustrated in FIG. 1. FIG. 3 is a schematic diagram depicting an example of current brightness distribution. FIGS. 4A and 4B are schematic diagrams depicting examples of target brightness distribution. FIG. 5 is a schematic diagram depicting a liquid crystal panel of which display screen is virtually divided into 4 x 4 divided areas. FIG. 6 is a schematic diagram depicting an example of a weakly increasing function. The signal processing by the video signal processor 120 of the first embodiment will be described with reference to FIG. 1 to FIG. 6.

As illustrated in FIG. 2, the video signal processor 120 includes a color analyzer 130, a brightness analyzer 140, a brightness distribution storage 150, a first determiner 160, a function storage 170 and a first correction processor 180. Further, the video signal processor 120 includes an inverse gamma (γ) circuit 181 and an inverse matrix circuit 182 on the input side. Furthermore, the video signal processor 120 includes a color correcting circuit 183, a matrix circuit 184 and a gamma (γ) circuit 185 on the output side.

The brightness distribution storage 150 stores information on current brightness distribution and target brightness distribution. The current brightness distribution is brightness distribution on the display screen of the liquid crystal panel 111 when the backlight 112 is turned on and the transmittance of the liquid crystal of each pixel of the liquid crystal panel 111 is set to 100%. The brightness distribution storage 150 stores two-dimensional brightness distribution information as current brightness distribution L10 as illustrated in FIG. 3, for example. The current brightness distribution depends on emission brightness characteristics of the backlight 112. When a light guiding plate or a diffuser is disposed, the current brightness distribution depends not only on the emission brightness characteristics of the backlight 112, but also on optical characteristics of the light guiding plate or the diffuser. As illustrated in FIG. 3, in the current brightness distribution L10, the brightness is normally the highest in the center portion of the display screen of the liquid crystal panel 111, then the brightness decreases in an area closer to the edge, and the brightness reaches the lowest at the four corners.

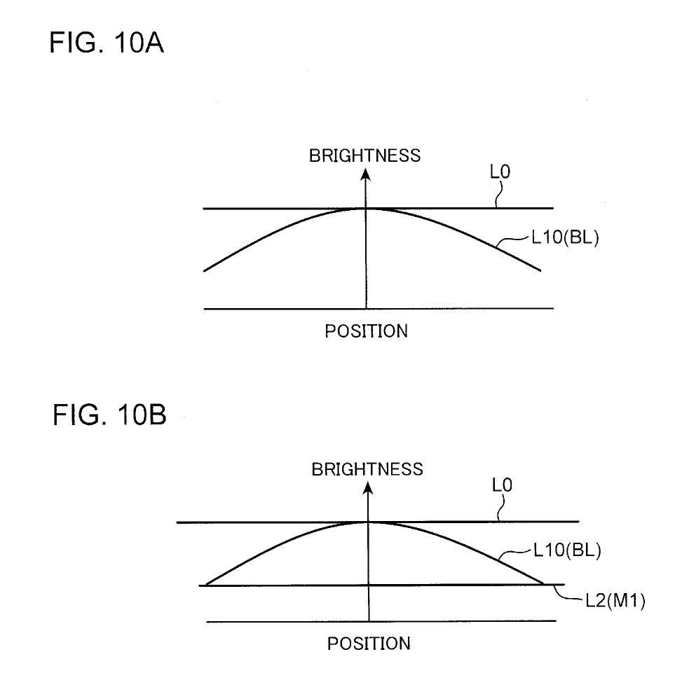

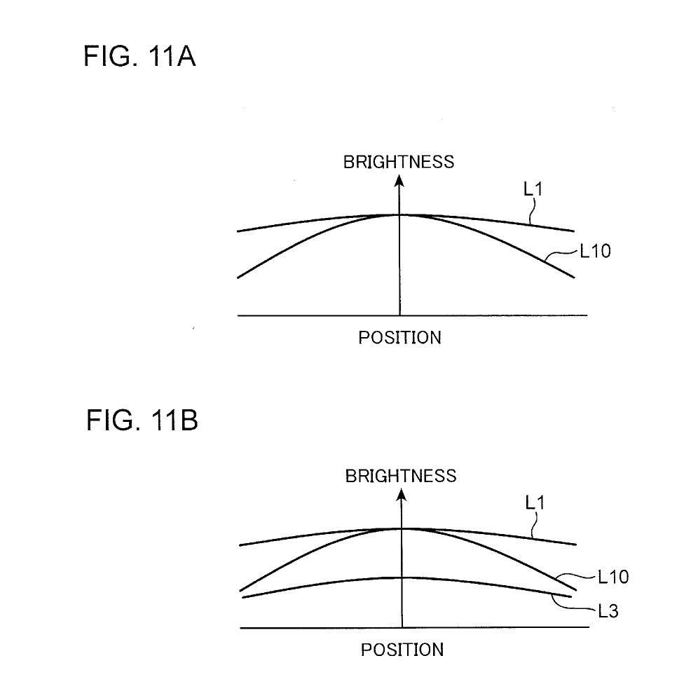

The target brightness distribution is brightness distribution that is targeted on the display screen of the liquid crystal panel 111 when the backlight 112 is turned on and the transmittance of the liquid crystal of each pixel on the liquid crystal panel 111 is set to 100%. According to the first embodiment, the target brightness distribution is set such that the inclination of the brightness change, with respect to the positional change, is gentler than the current brightness distribution, and the brightness values are not less than those of the current brightness distribution in a part or all of the areas. According to this embodiment, the target brightness distribution L0 is set to flat brightness distribution in which brightness does not change depending on the position, as illustrated in FIG. 4A. The target brightness distribution is not limited to the flat brightness distribution as illustrated in FIG. 4A. Alternatively, brightness distribution having a gentle inclination may be set for the target brightness distribution L1, as illustrated in FIG. 4B for example. However, as described above, the inclination of the target brightness distribution L1 is gentler than the current brightness distribution L10. The brightness distribution is two-dimensional distribution, as illustrated in FIG. 3, but in FIGS. 4A and 4B and in the later described FIGS. 10A, 10B, 11A and 11B, the brightness distribution is illustrated one-dimensionally to make description simpler.

In this embodiment, the brightness distribution storage 150 stores the target brightness distribution L0 and the current brightness distribution L10, but an embodiment is not limited to this. Alternatively, the brightness distribution storage 150 may store information on the difference between the target brightness distribution L0 and the current brightness distribution L10.

The video signal processor 120 increases the brightness data of the video signal, based on the brightness distribution information stored in the brightness distribution storage 150 and an allowable corrective increase amount. By this processing, the emission brightness distribution of the liquid crystal panel 111 may be approximated from the current brightness distribution to the target brightness distribution within a range where side effects are not generated, whereby a high quality image may be displayed.

The color analyzer 130 analyzes the color data of the input video signal to calculate, as a feature amount of the video signal, a color saturation degree. The brightness analyzer 140 analyzes the brightness data of the input video signal to calculate, as a feature amount of the video signal, a brightness saturation degree. The first determiner 160 calculates the allowable corrective increase amount of the brightness data based on the analysis results by the color analyzer 130 and the brightness analyzer 140. The first correction processor 180 increases the brightness data based on the allowable corrective increase amount calculated by the first determiner 160. In this embodiment, the color analyzer 130 corresponds to an example of the color data calculator, the brightness analyzer 140 corresponds to an example of the brightness data calculator, the function storage 170 corresponds to an example of the function data storage, and the first determiner 160 corresponds to an example of the parameter determiner. Further, in this embodiment, the color analyzer 130 and the brightness analyzer 140 correspond to examples of the first feature amount calculator, and the function storage 170, the first determiner 160 and the first correction processor 180 correspond to an example of the brightness increase processor.

First, the relationship between the allowable corrective increase amount of the brightness data and the color data of the video signal will be described. The input video signals are 8-bit R, G and B signals. For example, a case where R=255, G=0 and B=0 are input as the R, G and B signals and the brightness data of the input video signals are increased so as to approach the target brightness distribution L0 will be considered. To increase the brightness data, the R, G and B signals are converted to Y, Cb and Cr signals. The Y (brightness) data is increased by a difference between the target brightness distribution L0 and the current brightness distribution L10, for example. In this case, the Cb and Cr signals are corrected to increase by the amount of the increase of the Y data. It is assumed that R=300, G=50 and B=50 are the result of reconverting the Y, Cb and Cr signals into R, G and B signals after the increasing correction. In this case, the R signal exceeds 8 bits, and hence the value is clipped and the result becomes R=255, G=50 and B=50.Therefore, the color changes from the color of the R, G and B signals originally input. If one of the R, G and B signals has a value close to saturation, as in this example, the color of the displayed image may change between before and after the increasing correction. Therefore, in this case, the first determiner 160 calculates a small value as the allowable corrective increase amount of the brightness data.

The color analyzer 130 virtually divides the display screen of the liquid crystal panel 111 into 4×4 divided areas A1 to A16, as illustrated in FIG. 5 for example. The color analyzer 130 accumulates the maximum values of the R, G and B signals for each of the divided areas. Furthermore, the color analyzer 130 weights the accumulated value of each of the divided areas, and accumulates all of these weighted values. As will be noted from FIG. 3 and FIG. 4A, the difference between the target brightness distribution L0 and the current brightness distribution L10 is greatest at the four corners of the liquid crystal panel 111. Hence the color analyzer 130 sets the highest weighting factor for the divided areas A1, A4, A13 and A16, and performs accumulation. Based on this accumulation result, the first determiner 160 calculates the allowable corrective increase amount P1 as a numeric value in a 0≦P1≦255 range from the perspective of color data.

Next, the relationship between the allowable corrective increase amount of the brightness data and the brightness data of a video signal will be described. For example, in the case where an input video signal represents a high brightness image, in other words, in the case where the brightness has a value close to saturation, increasing the corrective increase amount of the brightness data is not preferable since contrast decreases. Therefore, when an image signal representing a high brightness image is input, the first determiner 160 calculates a small value as the allowable corrective increase amount.

In concrete terms, the brightness analyzer 140 accumulates a brightness value of the input video signal for each of the divided areas illustrated in FIG. 5, for example. Further, the brightness analyzer 140 weights an accumulated value of each of the divided areas, and accumulates all these weighted accumulated values. Here, just as in the case of the color analyzer 130, the brightness analyzer 140 sets the highest weighting factor for the divided areas A1, A4, A13 and A16 and performs accumulation. Based on this accumulation result, the first determiner 160 calculates the allowable corrective increase amount P2 as a numeric value in a 0≦P2≦255 range from the perspective of brightness data.

The first determiner 160 calculates the allowable corrective increase amount P0 considering the analysis results by both the color analyzer 130 and the brightness analyzer 140 by P0=P1×P2/255. In other words, the first determiner 160 quantitatively calculates the allowable corrective increase amount P0 as a numeric value in the 0≦P0≦255 range. The above calculation method is an example, and various processing methods are possible, such as P0=g(P1)×g(P2), where g(x) is a function that is set in advance.

The function storage 170 stores a weakly increasing function illustrated in FIG. 6. The weakly increasing function is a function that is y=x or more, and is a function by which the output value monotonously increases or remains the same as the input value increases. The weakly increasing function has a form similar to a gamma correction curve. The weakly increasing function includes plural functions f(α) corresponding to plural parameters α. In FIG. 6, only three functions are illustrated to simplify description. The plural functions included in the weakly increasing function are uniquely determined when the parameter is determined. The plural functions are set so that the function values increase or remain the same as the parameters increase. In other words, if α1<α2<α3, then f(α1)≦f(α2)≦f(α3) is established throughout all the input values.

The first determiner 160 determines, for each pixel, a parameter α of the weakly increasing function stored in the function storage 170 based on the difference between the target brightness distribution L0 and the current brightness distribution L10 in each pixel, and based on the calculated allowable corrective increase amount P0, and outputs the determined parameter α to the first correction processor 180. The inverse gamma circuit 181 linearizes the gamma (γ) characteristics of the input R, G and B video signals to 1.0. The inverse matrix circuit 182 converts the output signals of the inverse gamma circuit 181 into Y, Cb and Cr signals. The first correction processor 180 increases the input Y (brightness) data for each pixel, using the function f(α) corresponding to the α output from the first determiner 160. The color correction circuit 183 maintains the color balance by multiplying the Cb and Cr data by the ratio (output/input) of the Y data in the first correction processor 180. The matrix circuit 184 converts the Y, Cb and Cr data, corrected by the color correction circuit 183, into the R, G and B signals. The gamma circuit 185 sets the gamma (γ) characteristics of the R, G and B signals converted by the matrix circuit 184 to 0.45, and outputs these values to the liquid crystal driver 122.

As described above, in this first embodiment, the color analyzer 130 analyzes the color data of the input video signal, the brightness analyzer 140 analyzes the brightness data of the input video signal, and the first determiner 160 quantitatively calculates the allowable corrective increase amount of the brightness data based on these analysis results. Therefore, in the first embodiment, the display brightness data may be increased so as to implement the target brightness distribution, without degrading the quality of images displayed on the liquid crystal panel 111.

### Second Embodiment

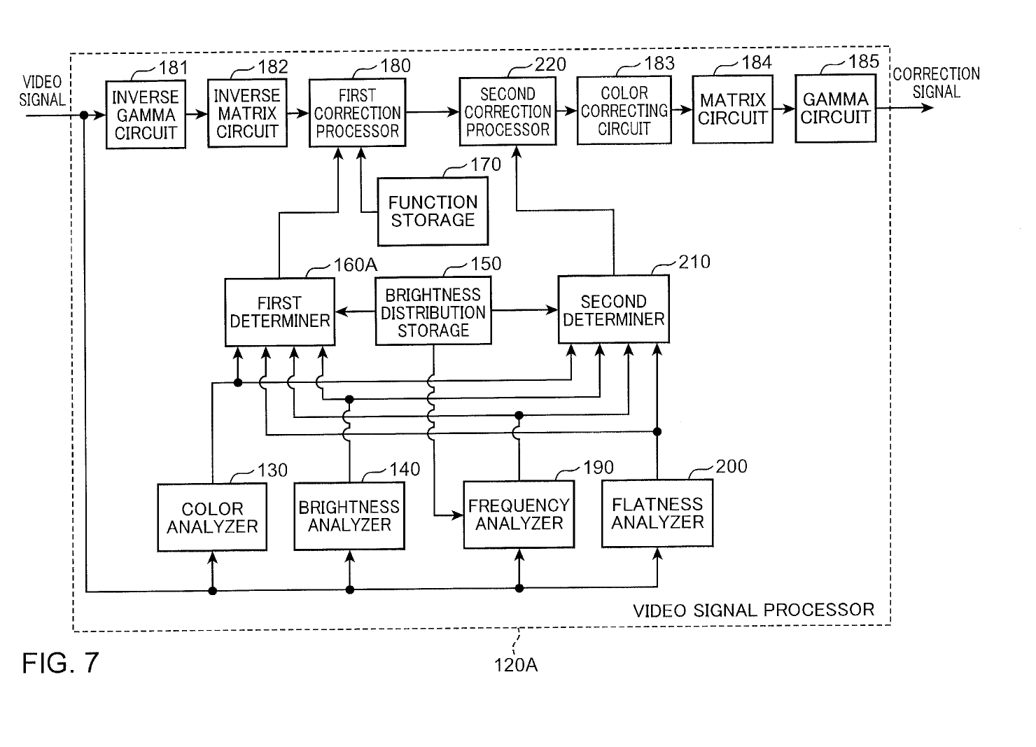

FIG. 7 is a block diagram depicting a configuration of a video signal processor disposed in a liquid crystal display device according to the second embodiment of the present invention. In the second embodiment, a composing element the same as the first embodiment is denoted with a same reference symbol. Now the liquid crystal device according to the second embodiment of the present invention will be described focusing on the differences from the first embodiment.

The liquid crystal display device according to the second embodiment includes a video signal processor 120A, instead of the video signal processor 120 of the first embodiment. In addition to each element of the video signal processor 120 of the first embodiment, the video signal processor 120A includes a frequency analyzer 190, a flatness analyzer 200, a second determiner 210 and a second correction processor 220. The video signal processor 120A also includes a first determiner 160A, instead of the first determiner 160 of the first embodiment.

In the second embodiment, the first determiner 160A not only calculates the allowable corrective increase amount based on the analysis results by the color analyzer 130 and the brightness analyzer 140, but also calculates a required corrective increase amount based on the analysis results by the frequency analyzer 190 and the flatness analyzer 200. The frequency analyzer 190 and the flatness analyzer 200 calculate a feature amount of the input video signal. The frequency analyzer 190 and the flatness analyzer 200 will now be described in sequence.

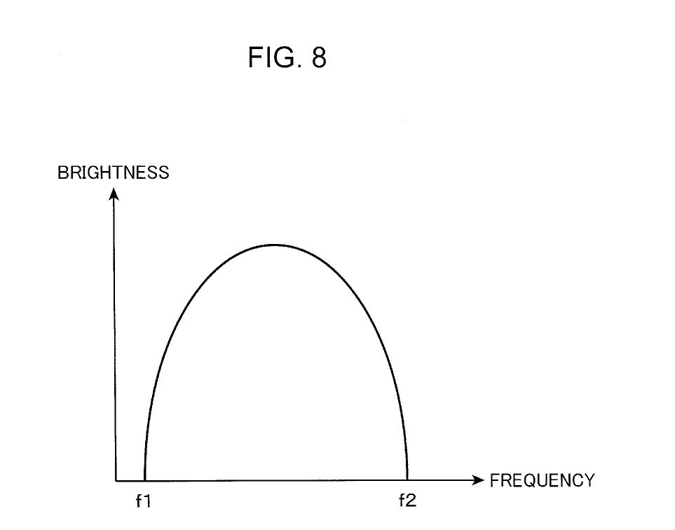

FIG. 8 is a schematic diagram depicting an example of an analysis result by the frequency analyzer 190. The frequency analyzer 190 filters the input video signal with a predetermined frequency band from f1 to f2, and calculates an accumulated value of the brightness components included in the filtering result, as the feature amount of the video signal. The frequency analyzer 190 filters the video signal for each of the divided areas A1 to A16 illustrated in FIG. 5.

The frequency analyzer 190 determines a cut-off frequency f1 at the low frequency side, and a cut-off frequency f2 at the high frequency side based on the current brightness distribution L10 stored in the brightness distribution storage 150. The frequency analyzer 190 determines the cut-off frequencies f1 and f2 based on whether or not the inclination (change rate) of the difference of the current brightness distribution L10 with respect to the target brightness distribution L0 disappears in the image to be unnoticeable. The frequency analyzer 190 determines the cut-off frequencies f1 and f2 for each of the divided areas A1 to A16.

When the inclination of the difference of the current brightness distribution L10 with respect to the target brightness distribution L0 is gentle, the frequency analyzer 190 sets the cut-off frequency f1 at the low frequency side to a relatively low value, since the inclination disappears in the image to be unnoticeable even in the low frequency video signal. When the inclination of the difference of the current brightness distribution L10 with respect to the target brightness distribution L0 is sharp, the frequency analyzer 190 sets the cut-off frequency f1 to a relatively high value, since the inclination does not disappear in the image to be noticeable in the low frequency video signal.

When the inclination of the difference of the current brightness distribution L10 with respect to the target brightness distribution L0 is gentle, the gentle inclination is rather noticeable in the video signal of which frequency is very high, as in a checkered pattern. Therefore, when the inclination of the above-described difference is gentle, the frequency analyzer 190 sets the cut-off frequency f2 at the high frequency side to a relatively low value. When the inclination of the above-described difference is sharp, the frequency analyzer 190 sets the cut-off frequency f2 to a relatively high value, since the inclination disappears in the image to be unnoticeable in the high frequency video signal.

In this embodiment, the frequency analyzer 190 determines the cut-off frequencies f1 and f2 for each of the divided areas in FIG. 5, but an embodiment is not limited to this. Alternatively, the frequency analyzer 190 may determine the common cut-off frequencies f1 and f2 for all the divided areas A1 to A16. Further, the frequency analyzer 190 may analyze a frequency using only one of the horizontal components or the vertical components of the display screen on which an input image is displayed.

In this embodiment, the frequency analyzer 190 cuts off the video signal by filtering the high frequency side of not less than the predetermined frequency f2 and the low frequency side of not more than the predetermined frequency f1, but an embodiment is not limited to this. Alternatively, the frequency analyzer 190 may cut off the video signal using a filter with an inclination so that the high frequency components or the low frequency components are gradually cut off according to the need.

When the calculation result (accumulated value of the brightness components included in the filtering result) by the frequency analyzer 190 is large, the difference between the target brightness distribution L0 and the current brightness distribution L10 (FIG. 4A) disappears in the image to be unnoticeable. Hence, the first determiner 160A judges that the required correction amount of the brightness data is small. When the calculation result (accumulated value of the brightness components included in the filtering result) by the frequency analyzer 190 is small, the difference between the target brightness distribution L0 and the current brightness distribution L10 (FIG. 4A) does not disappear in the image to be noticeable. Hence, the first determiner 160A judges that the required correction amount of the brightness data is large. Based on the calculation result by the frequency analyzer 190, the first determiner 160A calculates the required corrective increase amount P3 in terms of the frequency as a numeric value in a 0≦P3≦255 range.

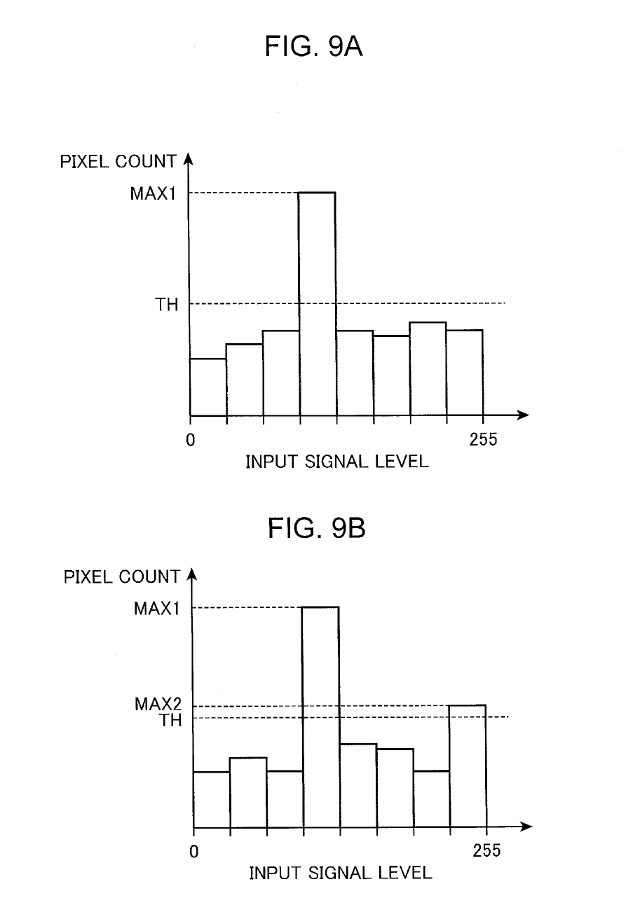

FIG. 9A is a schematic diagram depicting an example of a brightness histogram generated by the flatness analyzer 200, and FIG. 9B is a schematic diagram depicting another example of the brightness histogram. The flatness analyzer 200 generates a brightness histogram based on the input video signal. The flatness analyzer 200 calculates the degree of certainty of flatness of the display brightness data of the video signal based on the generated brightness histogram.

When the display brightness data of the video signal is flat, the inclination of the current brightness distribution L10 is noticeable. Hence, the first determiner 160A judges that the required corrective increase amount is large, when the degree of certainty of flatness of the display brightness data of the video signal, calculated by the flatness analyzer 200, is high, and judges that the required corrective increase amount is small when the calculated degree of certainty of flatness is low.

In this embodiment, the flatness analyzer 200 divides a range of the input signal levels 0 to 255 into eight divided ranges, as illustrated in FIG. 9A for example. The flatness analyzer 200 accumulates pixel counts every divided ranges, each pixel having a level within the divided range. As illustrated in FIG. 9A, when the highest accumulated value MAXI exceeds a predetermined threshold value TH (MAX1>TH), the flatness analyzer 200 judges that the degree of certainty of flatness is higher as the exceeding difference (MAX1−TH) is greater. Based on the difference (MAX1−TH), the flatness analyzer 200 calculates the degree of certainty of flatness P10 as a numeric value in a 0≦P10≦255 range.

The flatness analyzer 200 calculates the degree of certainty of flatness based only on the highest accumulated value MAX1, but an embodiment is not limited to this. Alternatively, the flatness analyzer 200 may calculate the degree of certainty of flatness using the highest accumulated value MAX1 and the second highest accumulated value MAX2. For example, when (MAX1+MAX2)>TH, the flatness analyzer 200 may calculate the degree of certainty of flatness based on the difference (MAX1+MAX2−TH). Still alternatively, when (MAX1×MAX2)>TH, the flatness analyzer 200 may calculate the degree of certainty of flatness based on the difference (MAX1×MAX2−TH). Further alternatively, the flatness analyzer 200 may calculate the degree of certainty of flatness using only the second highest accumulated value MAX2. For example, as illustrated in FIG. 9B, when MAX2>TH, the flatness analyzer 200 may calculate the degree of certainty of flatness based on the exceeding difference (MAX2−TH). In these embodiments, the second highest accumulated value MAX2 to be used is at least three divided ranges distant from the highest accumulated value MAX1.

As illustrated in FIG. 9A, the flatness analyzer 200 divides the input signal level into eight divided ranges, but an embodiment is not limited to this. Alternatively, the flatness analyzer 200 may divide the input signal level into 16 divided ranges.

Based on the degree of certainty of flatness calculated by the flatness analyzer 200, the first determiner 160A calculates the required corrective increase amount P4 in terms of flatness as a numeric value in a 0≦P4≦255.

The first determiner 160A calculates the required corrective increase amount P5 considering both of the analysis results by the frequency analyzer 190 and the flatness analyzer 200 by P5=P3×P4/256. In other words, the first determiner 160A quantitatively calculates the required corrective increase amount P5 as a numeric value in a 0≦P5≦255 range.

Just like the first determiner 160 of the first embodiment, the first determiner 160A calculates the allowable corrective increase amount P1 in terms of the color data as a numeric value in a 0≦P1≦255 range based on the analysis result by the color analyzer 130. Further, just like the first determiner 160 of the first embodiment, the first determiner 160A calculates the allowable corrective increase amount P2 in terms of the brightness data as a numeric value in 0≦P2≦255 range based on the analysis result by the brightness analyzer 140. Further, just like the first determiner 160 of the first embodiment, the first determiner 160A calculates the allowable corrective increase amount P0 considering both of the analysis results by the color analyzer 130 and the brightness analyzer 140 by P0=P1×P2/256.

Furthermore, the first determiner 160A calculates an corrective increase amount P6 combining the allowable corrective increase amount P0 and the required corrective increase amount P5 by P6=P0×P5/256. In other words, the first determiner 160A quantitatively calculates the corrective increase amount P6 as a numeric value in a 0≦P6≦255 range.

Based on the difference between the target brightness distribution L0 and the current brightness distribution L10 in each pixel, and based on the calculated corrective increase amount P6, the first determiner 160A determines a parameter α of the weakly increasing function stored in the function storage 170 for each pixel, and outputs the parameter α to the first correction processor 180. The first correction processor 180 generates a correction signal by increasing the brightness data of the input video signal for each pixel, using the function f(α) corresponding to the parameter α that is output from the first determiner 160A. The first correction processor 180 outputs the generated correction signal to the second correction processor 220. In this embodiment, the frequency analyzer 190 and the flatness analyzer 200 correspond to examples of the second feature amount calculator, and the first determiner 160A and the first correction processor 180 correspond to an example of the brightness increase processor. In this embodiment, the frequency analyzer 190 corresponds to an example of the frequency calculator, and the flatness analyzer 200 corresponds to an example of the flatness calculator.

The second determiner 210 determines a parameter for corrective suppression for the display brightness data of the video signal. The second determiner 210 creates a second target brightness distribution as a target for corrective suppression for the brightness using the target brightness distribution stored in the brightness distribution storage 150. The target brightness distribution stored in the brightness distribution storage 150 is called the “first target brightness distribution” hereinbelow to simplify description.

FIGS. 10A and 10B are schematic diagrams depicting an example of the second target brightness distribution used for the brightness corrective suppression. FIGS. 11A and 11B are schematic diagrams depicting another example of the second target brightness distribution used for brightness corrective suppression. The second target brightness distribution created by the second determiner 210 will be described with reference to FIGS. 10A, 10B, 11A and 11B.

The second determiner 210 creates the second target brightness distribution by performing a predetermined operation on the first target brightness distribution that is used for the brightness increase processing. The second target brightness distribution is brightness distribution that is correlated with the first target brightness distribution. The second determiner 210 creates the second target brightness distribution which has a similar form as the first target brightness distribution and has a brightness level not exceeding the current brightness distribution.

The second determiner 210 creates the second target brightness distribution by parallel-shifting the first target brightness distribution downward. Alternatively, the second determiner 210 may create the second target brightness distribution by multiplying the first target brightness distribution by a predetermined value less than 1 (e.g. 0.9). Still alternatively, the second determiner 210 may create the second target brightness distribution which is similar figure of the first target brightness distribution. Further alternatively, the second determiner 210 may create the second target brightness distribution using the result of the brightness increasing processing by the first correction processor 180.

In FIG. 10A, the first target brightness distribution L0 and the current brightness distribution L10 stored in the brightness distribution storage 150 are illustrated. In FIG. 10B, the second target brightness distribution L2 generated by parallel-shifting the first target brightness distribution L0 downward is illustrated. The second target brightness distribution L2 is created so as to pass through the minimum value of the current brightness distribution L10. In FIG. 11A, the first target brightness distribution L1 of which form is different from the first target brightness distribution L0 illustrated in FIG. 10A, and the current brightness distribution L10, are illustrated. In FIG. 11B, the second target brightness distribution L3 generated by multiplying the first target brightness distribution L1 by a predetermined value less than 1 is illustrated. As illustrated in FIG. 11B, the second target brightness distribution L3 is located not to exceed the current brightness distribution L10.

Referring back to FIG. 7, the second determiner 210 determines a brightness suppression parameter for corrective suppression for the brightness toward the second target brightness distribution using analysis results by the color analyzer 130, the brightness analyzer 140, the frequency analyzer 190 and the flatness analyzer 200.

After the brightness is subjected to corrective increase by the first correction processor 180, the second correction processor 220 suppresses the brightness, which has not reached the first target brightness distribution, toward the second target brightness distribution, which is created by the second determiner 210 and has a form similar to the first target brightness distribution. By performing this control, the overall brightness decreases, but quality of the image after correction may be enhanced. The second determiner 210 acquires the required correction amount from the frequency analyzer 190 and the flatness analyzer 200. Further, the second determiner 210 may acquire information on the correction amount in the brightness increase processing from the color analyzer 130 and the brightness analyzer 140. Therefore, the second determiner 210 may comprehensively judge the suppressing amount not only from the frequency analyzer 190 and the flatness analyzer 200, but also from the color analyzer 130 and the brightness analyzer 140. The processing result data by the first correction processor 180 or the corrective increase parameter α by the first determiner 160A is not directly received here, because the second correction processor 220 may analyze with higher flexibility. Alternatively, the second determiner 210 may perform processing to directly receive the corrective increase parameter α by the first determiner 160A.

Just like the first determiner 160A, the second determiner 210 uses the analysis result by the frequency analyzer 190. In other words, when the calculation result by the frequency analyzer 190 (accumulated value of brightness components included in the filtering result) is small, the second determiner 210 judges that the required correction amount of brightness is large. Based on the calculation result by the frequency analyzer 190, the second determiner 210 calculates the required corrective suppression amount P21 in terms of frequency as a numeric value in a 0≦P21≦255 range.

Just like the first determiner 160A, the second determiner 210 uses the analysis result by the flatness analyzer 200. In other words, when the degree of certainty of flatness of the display brightness data of the video signal calculated by the flatness analyzer 200 is high, the second determiner 210 judges that the required corrective suppression amount is large, and when the calculated degree of certainty of flatness is low, the second determiner 210 judges that the required corrective suppression amount is small. Based on the degree of certainty of flatness calculated by the flatness analyzer 200, the second determiner 210 calculates the required corrective suppression amount P22 in terms of the degree of certainty of flatness as a numeric value in a 0≦P22≦255 range.

The second determiner 210 calculates the corrective suppression amount P23 combining the required corrective suppression amount P21 and the required corrective suppression amount P22 by P23=P21×P22/256. In other words, the second determiner 210 quantitatively calculates the corrective suppression amount P23 as a numeric value in a 0≦P23≦255 range. Further, the second determiner 210 normalizes the corrective suppression amount P23 with the maximum value as 1 to determine the brightness suppression parameter β as a value in 0≦β≦1.

Alternatively, in determining the brightness suppression parameter β, the second determiner 210 may use the allowable corrective increase amount P0 in addition to the above-described processing. In other words, when the corrective suppression amount P23 is large and the allowable corrective increase amount P0 is small, the second determiner 210 may calculate the corrective suppression amount P24 combining the corrective suppression amount P23 and the allowable corrective increase amount P0 by P24=P23×(255−P0)/256 so as to increase the corrective suppression amount. In this way, the second determiner 210 quantitatively calculates the corrective suppression amount P24 as a numeric value in a 0≦P24≦255 range. Further, the second determiner 210 normalizes the corrective suppression amount P24 with the maximum value as 1 to determine the brightness suppression parameter β as a value in 0≦β≦1.

Based on the brightness suppression parameter β determined by the second determiner 210, the second correction processor 220 performs brightness suppressing processing to a correction signal (corrected image brightness data for each pixel) output from the first correction processor 180. In this embodiment, the second determiner 210 and the second correction processor 220 correspond to an example of the brightness suppressing processor.

An example of processing by the second correction processor 220 will be described with reference to FIG. 10B. In FIG. 10B, BL denotes a brightness value of the current brightness distribution L10, and M1 denotes a brightness value of the second target brightness distribution L2.

A correction signal Ydn after brightness is suppressed is given by

Ydn=Yup×{1−(1−M1/BL)×β} (Expression 1),

where Yup denotes a correction signal after brightness is increased. For example, if M1/BL=0.7 and β=0.5, then Ydn=Yup×0.85. This means that suppression to M1/BL=0.7 is required in order for the brightness distribution to match with the second target brightness distribution. However, the brightness distribution has been close to the initial first target brightness distribution due to the brightness increase processing by the first correction processor 180. Hence, a degree of suppression is controlled by the brightness suppression parameter β.

In the second embodiment, the color correcting circuit 183 is included, just like the first embodiment. The color correcting circuit 183 calculates the input-output gain, where input is the input image brightness of the first correction processor 180, and output is the output image brightness of the second correction processor 220, and multiplies Cb and Cr data by this gain.

Thus, in the second embodiment, the first determiner 160A calculates the required corrective increase amount, in addition to the allowable corrective increase amount, and makes corrective increase for the brightness considering the required corrective increase amount as well. In other words, in the case where the current brightness distribution is decreased from the target brightness distribution, brightness is increased when the brightness is required to be increased. Hence, an image with excellent quality may be displayed. Further, brightness is not subjected to corrective increase when it is not required to increase the brightness. Hence, side effects by useless brightness corrective increase may be prevented.

The second determiner 210 calculates the required corrective suppression amount using the analysis results by the frequency analyzer 190 and the flatness analyzer 200, and makes corrective suppression for the brightness considering the required corrective suppression amount. By performing corrective suppression for the brightness within a range that does not generate side effects, it is possible to prevent an excessive decrease in the brightness. In other words, by performing corrective increase for brightness and corrective suppression for brightness based on the feature amount of the video signal, it is possible to perform correction with an optimum balance between the effect of the correction and side effects of the correction.

In the second embodiment, the second determiner 210 sets the brightness suppression parameter β to a same value for the entire screen. Thereby visual recognition of the boundary, generated by setting the brightness suppression parameter β for each of the divided areas, may be prevented.

In the second embodiment, the first correction processor 180, after performing the brightness increase processing using the weakly increasing function considering visual properties, implements brightness distribution that is similar to the form of the first target brightness distribution.

### Third Embodiment

As described above, in the technique disclosed in Patent Document 1, in correcting the video signal, gamma correction is performed according to the signal level and the position of the input video signal on the entire display screen. In the meantime, the necessity of correcting brightness is either high or low depending on the feature amount of the input video signal. However, in the technique disclosed in Patent Document 1, correction is performed regardless the input video signal, and the necessity of correcting brightness, depending on the feature amount of the video signal, is not considered. Therefore, even if the necessity of correcting brightness is low, the brightness is corrected. Hence, problems may be generated in the case of the technique disclosed in Patent Document 1, such as degrading the quality of a displayed image.

In the third embodiment, degrading the quality of a displayed image is prevented by appropriately correcting the brightness in response to the feature amount of the input video signal.

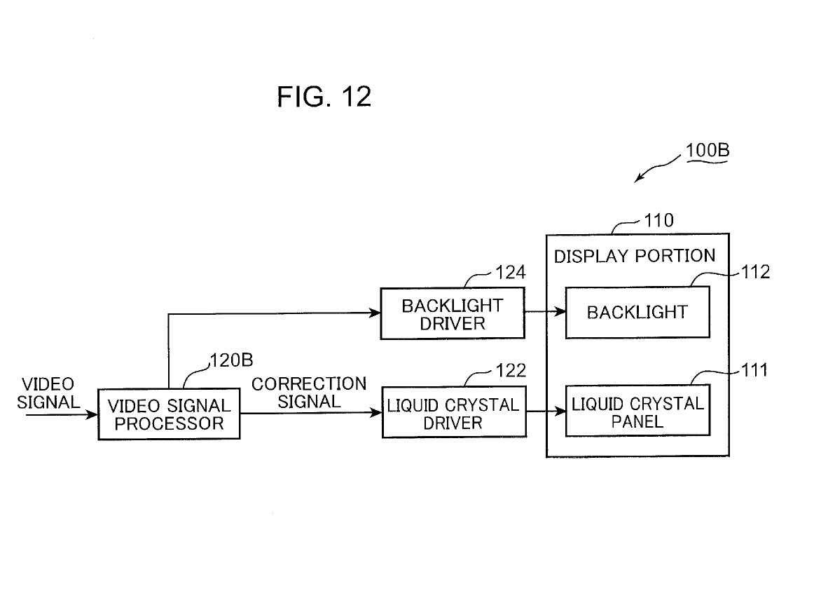

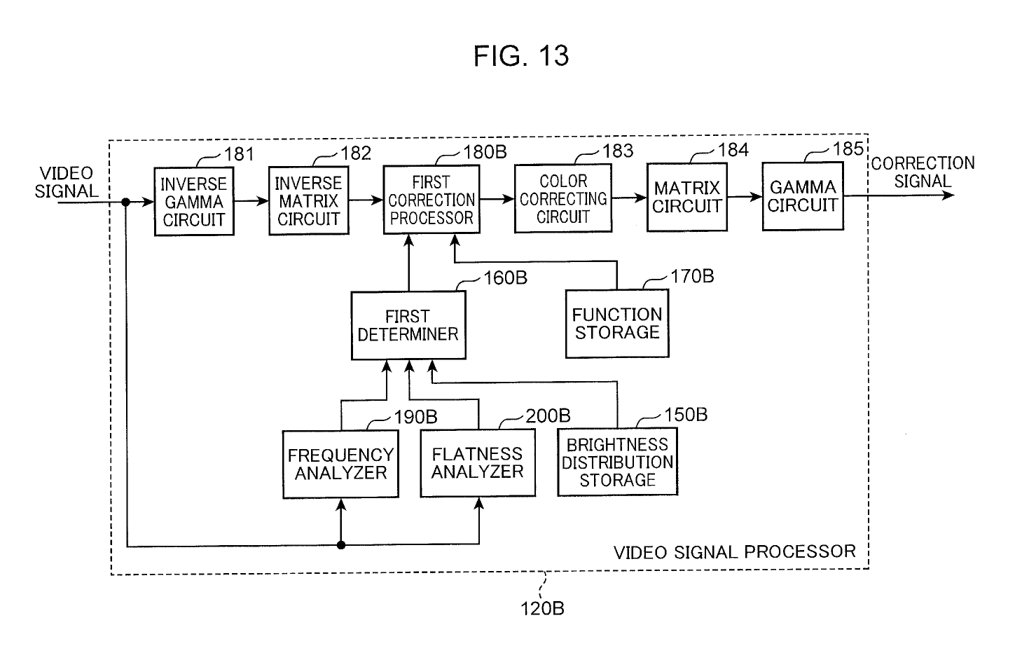

FIG. 12 is a block diagram depicting a configuration of a liquid crystal display device according to the third embodiment of the present invention. FIG. 13 is a block diagram depicting a configuration of the video signal processor 120B illustrated in FIG. 12. In the third embodiment, a composing element the same as the first and second embodiments is denoted with a same reference symbol. Now the liquid crystal display device according to the third embodiment of the present invention will be described focusing on the differences from the first and second embodiments.

As illustrated in FIG. 12, the liquid crystal display device 100B according to the third embodiment includes the video signal processor 120B instead of the video signal processor 120 in the liquid crystal display device 100 of the first embodiment. As illustrated in FIG. 13, the video signal processor 120B does not include the color analyzer 130 and the brightness analyzer 140 of the video signal processor 120 of the first embodiment, but includes a frequency analyzer 190B and a flatness analyzer 200B. Further, the video signal processor 120B includes a brightness distribution storage 150B instead of the brightness distribution storage 150 in the video signal processor 120 of the first embodiment, includes a first determiner 160B instead of the first determiner 160, includes a function storage 170B instead of the function storage 170, and includes a first correction processor 180B instead of the first correction processor 180.

The video signal processor 120B corrects an input video signal to generate a correction signal, and outputs the generated correction signal to the liquid crystal driver 122. The video signal processor 120B also outputs a control signal to the backlight driver 124 to turn the backlight 112 on.

The brightness distribution storage 150B stores information on current brightness distribution and target brightness distribution. The current brightness distribution is brightness distribution on the display screen of the liquid crystal panel 111 when the backlight 112 is turned on and the transmittance of the liquid crystal of each pixel on the liquid crystal panel 111 is set to 100%. The brightness distribution storage 150B stores two-dimensional brightness distribution information as the current brightness distribution L10, as illustrated in FIG. 3 for example. The current brightness distribution depends on emission brightness characteristics of the backlight 112.

When a guiding plate or a diffuser is disposed, the current brightness distribution depends not only on the emission brightness characteristics of the backlight 112, but also on optical characteristics of the light guiding plate or the diffuser. As illustrated in FIG. 3, in the current brightness distribution L10, the brightness is normally highest in the center portion of the display screen of the liquid crystal panel 111, then the brightness decreases in an area closer to the edge, and the brightness reaches the lowest at the four corners.

The target brightness distribution is brightness distribution that is targeted on the display screen of the liquid crystal panel 111 when the backlight 112 is turned on and the transmittance of the liquid crystal of each pixel of the liquid crystal panel 111 is set to 100%. According to the third embodiment, the target brightness distribution is set such that the inclination of the brightness change, with respect to the positional change, is gentler than the current brightness distribution, and the brightness values are not less than those of the current brightness distribution in a part or all of the areas. According to this embodiment, the target brightness distribution L0 is set to flat brightness distribution in which brightness does not change depending on the position, as illustrated in FIG. 4A.

The target brightness distribution is not limited to the flat brightness distribution as illustrated in FIG. 4A. Alternatively, the brightness distribution having a gentle inclination may be set for the target brightness distribution L1, as illustrated in FIG. 4B, for example. However as described above, the inclination of the target brightness distribution L1 is gentler than the current brightness distribution L10. The brightness distribution is two-dimensional distribution, as illustrated in FIG. 3, but in FIGS. 4A and 4B, the brightness distribution is illustrated one-dimensionally to make description simpler.

In this embodiment, the brightness distribution storage 150B stores the target brightness distribution L0 and the current brightness distribution L10, but an embodiment is not limited to this. Alternatively, the brightness distribution storage 150B may store information on the difference between the target brightness distribution L0 and the current brightness distribution L10.

The video signal processor 120B increases the brightness data of the video signal, based on the brightness distribution information stored in the brightness distribution storage 150B and a required corrective increase amount, so that the image that is displayed when the liquid crystal panel 111 is illuminated by the target brightness distribution is implemented. By this processing, it is possible to display the image on the display portion 110 so that the emission brightness distribution of the liquid crystal panel 111 becomes similar to the target brightness distribution.

The frequency analyzer 190B and the flatness analyzer 200B calculate the feature amount of the video signal, respectively. The first determiner 160B calculates the required corrective increase amount based on the calculation results by the frequency analyzer 190B and the flatness analyzer 200B. The first correction processor 180B corrects the input video signal based on the required corrective increase amount calculated by the first determiner 160B. In this embodiment, the frequency analyzer 190B and the flatness analyzer 200B correspond to examples of the feature amount calculator, and the first determiner 160B and the first correction processor 180B correspond to an example of the brightness increase processor. In this embodiment, the frequency analyzer 190B corresponds to an example of the frequency calculator, and the flatness analyzer 200B corresponds to an example of the flatness calculator.

As illustrated in FIG. 8, the frequency analyzer 190B filters the input video signal with a predetermined frequency band from f1 to f2, and calculates an accumulated value of the brightness components included in the filtering result, as the feature amount of the video signal. The frequency analyzer 190B virtually divides the display screen of the liquid crystal panel 111 into 4 x 4 divided areas A1 to A16, as illustrated in FIG. 5, for example. The frequency analyzer 190B filters the video signal for each of the divided areas A1 to A16 illustrated in FIG. 5. The frequency analyzer 190B calculates an accumulated value of the brightness components included in the filtering result, for each of the divided areas A1 to A16.

Furthermore, the frequency analyzer 190B weights the accumulated value of each of the divided areas A1 to A16, and accumulates all of the weighted values. As will be noted from FIG. 3 and FIG. 4A, the difference between the target brightness distribution L0 and the current brightness distribution L10 is greatest at the four corners of the liquid crystal panel 111. Hence the frequency analyzer 190B sets the highest weighting factor for the divided areas A1, A4, A13 and A16, and performs accumulation.

The frequency analyzer 190B determines a cut-off frequency f1 at the low frequency side and a cut-off frequency f2 at the high frequency side based on the current brightness distribution L10 stored in the brightness distribution storage 150B. The frequency analyzer 190B determines the cut-off frequencies f1 and f2 based on whether or not the inclination (change rate) of the difference of the current brightness distribution L10 with respect to the target brightness distribution L0 disappears in the image to be unnoticeable. The frequency analyzer 190B determines the cut-off frequencies f1 and f2 for each of the divided areas A1 to A16.

When the inclination of the difference of the current brightness distribution L10 with respect to the target brightness distribution L0 is gentle, the frequency analyzer 190B sets the cut-off frequency f1 at the low frequency side to a relatively low value, since the inclination disappears in the image to be unnoticeable even in the low frequency video signal. When the inclination of the difference of the current brightness distribution L10 with respect to the target brightness distribution L0 is sharp, the frequency analyzer 190B sets the cut-off frequency f1 to a relatively high value, since the inclination does not disappear in the image to be noticeable in the low frequency video signal.

When the inclination of the difference of the current brightness distribution L10 with respect to the target brightness distribution L0 is gentle, the gentle inclination is rather noticeable in the video signal of which frequency is very high, as in a checkered pattern. Therefore, when the inclination of the above-described difference is gentle, the frequency analyzer 190B sets the cut-off frequency f2 at the high frequency side to a relatively low value. When the inclination of the above-described difference is sharp, the frequency analyzer 190B sets the cut-off frequency f2 to a relatively high value, since the inclination disappears in the image to be unnoticeable in the high frequency video signal.

In this embodiment, the frequency analyzer 190B determines the cut-off frequencies f1 and f2 for each of the divided areas in FIG. 5, but an embodiment is not limited to this. Alternatively, the frequency analyzer 190B may determine the common cut-off frequencies f1 and f2 for all the divided areas A1 to A16. The frequency analyzer 190B may analyze a frequency using only one of the horizontal components or the vertical components of the display screen on which an input image is displayed.

In this embodiment, the frequency analyzer 190B cuts off the video signal by filtering the high frequency side of not less than the predetermined frequency f2 and the low frequency side of not more than the predetermined frequency f1, but an embodiment is not limited to this. Alternatively, the frequency analyzer 190B may cut off the video signal using a filter with an inclination so that the high frequency components or the low frequency components are gradually cut off according to the need.

When the calculation result (accumulated value of the brightness components included in the filtering result) by the frequency analyzer 190B is large, the difference between the target brightness distribution L0 and the current brightness distribution L10 (FIG. 4A) disappears in the image to be unnoticeable. Hence, the first determiner 160B judges that the required corrective increase amount of the brightness data is small. When the calculation result (accumulated value of the brightness components included in the filtering result) by the frequency analyzer 190B is small, the difference between the target brightness distribution L0 and the current brightness distribution L10 (FIG. 4A) does not disappear in the image to be noticeable. Hence, the first determiner 160B judges that the required corrective increase amount of the brightness is large. Based on the calculation result by the frequency analyzer 190B, the first determiner 160B calculates the required corrective increase amount P33 in terms of the frequency as a numeric value in a 0≦P33≦255 range.

As illustrated in FIG. 9, the flatness analyzer 200B generates a brightness histogram based on the input video signal. The flatness analyzer 200B calculates the degree of certainty of flatness of the display brightness data of the video signal based on the generated brightness histogram.

When the display brightness data of the video signal is flat, the inclination of the current brightness distribution L10 is noticeable. Hence, the first determiner 160B judges that the required corrective increase amount is large, when the degree of certainty of flatness of the display brightness data of the video signal, calculated by the flatness analyzer 200B, is high, and judges that the required corrective increase amount is small when the calculated degree of certainty of flatness is low.

In this embodiment, the flatness analyzer 200B divides a range of the input signal levels 0 to 255 into eight divided ranges, as illustrated in FIG. 9A for example. The flatness analyzer 200B accumulates, for each of the divided ranges, a pixel count of pixels having a level of each of the divided ranges. As illustrated in FIG. 9A, when the highest accumulated value MAXI exceeds a predetermined threshold value TH (MAX1>TH), the flatness analyzer 200B judges that the degree of certainty of flatness is higher as the exceeding difference (MAX1−TH) is greater. Based on the difference (MAX1−TH), the flatness analyzer 200B calculates the degree of certainty of flatness P30 as a numeric value in a 0≦P30≦255 range. Based on the degree of certainty of flatness calculated by the flatness analyzer 200B, the first determiner 160B calculates the required corrective increase amount P34 in terms of the flatness as a numeric value in a 0≦P34≦255 range.

In this embodiment, the flatness analyzer 200B calculates the degree of certainty of flatness based only on the highest accumulated value MAX1, but an embodiment is not limited to this. Alternatively, the flatness analyzer 200B may calculate the degree of certainty of flatness using the highest accumulated value MAXI and the second highest accumulated value MAX2. For example, when (MAX1+MAX2)>TH, the flatness analyzer 200B may calculate the degree of certainty of flatness based on the difference (MAX1+MAX2−TH). Still alternatively, when (MAX1×MAX2)>TH, the flatness analyzer 200B may calculate the degree of certainty of flatness based on the difference (MAX1×MAX2−TH). Further alternatively, the flatness analyzer 200B may calculate the degree of certainty of flatness using only the second highest accumulated value MAX2. For example, as illustrated in FIG. 9B, when MAX2>TH, the flatness analyzer 200B may calculate the degree of certainty of flatness based on the exceeding difference (MAX2−TH). In these configurations, the second highest accumulated value MAX2 to be used is at least three divided ranges distant from the highest accumulated value MAX1.

As illustrated in FIG. 9A, the flatness analyzer 200B divides the input signal level into eight divided ranges, but an embodiment is not limited to this. Alternatively, the flatness analyzer 200B may divide the input signal level into 16 divided ranges.

The function storage 170B stores a weakly increasing function illustrated in FIG. 6. The weakly increasing function is a function that is y=x or more, and is a function by which the output value monotonously increases or remains the same as the input value increases. The weakly increasing function has a form similar to a gamma correction curve. The weakly increasing function includes plural functions f(α) corresponding to plural parameters α. In FIG. 6, only three functions are illustrated to simplify description. The plural functions included in the weakly increasing function are uniquely determined when parameters are determined. The plural functions are set so that the function values increase or remain the same as the parameters increase. In other words, if α1<α2<α3, then f(α1)≦f(α2)≦f(α3) is established throughout all the input values.

The first determiner 160B calculates the required corrective increase amount P35 considering the analysis results by both the frequency analyzer 190B and the flatness analyzer 200B by P35=P33×P34/256. In other words, the first determiner 160B quantitatively calculates the required corrective increase amount P35 as a numeric value in a 0≦P35≦255 range.

The first determiner 160B determines, for each pixel, a parameter α of the weakly increasing function stored in the function storage 170B based on the difference between the target brightness distribution L0 and the current brightness distribution L10 in each pixel, and based on the calculated required corrective increase amount P35, and outputs the determined parameter α to the first correction processor 180B.

The inverse gamma circuit 181 linearizes the gamma (γ) characteristics of the input R, G and B video signals to 1.0. The inverse matrix circuit 182 converts the output signals of the inverse gamma circuit 181 into Y, Cb and Cr signals. The first correction processor 180B increases the input Y (brightness) data for each pixel, using the function f(α) corresponding to the parameter α output from the first determiner 160B. The color correction circuit 183 maintains the color balance by multiplying the Cb and Cr data by the ratio (output/input) of the Y data in the first correction processor 180B. The matrix circuit 184 converts the Y, Cb and Cr data, corrected by the color correction circuit 183, into R, G and B signals. The gamma circuit 185 sets the gamma (γ) characteristics of the R, G and B signals converted by the matrix circuit 184 to 0.45, and outputs these values to the liquid crystal driver 122.

As described above, in the third embodiment, the frequency analyzer 190B analyzes the frequency of the input video signal, the flatness analyzer 200B analyzes the flatness of the input video signal, and the first determiner 160B quantitatively calculates the required corrective increase amount of the brightness data based on these analysis results. Therefore, in the third embodiment, by performing corrective increase for the brightness within a range not to generate side effects, the emission brightness distribution of the liquid crystal panel 111 is approximated from the current brightness distribution to the target brightness distribution, which makes it possible to display high quality image.

### Fourth Embodiment

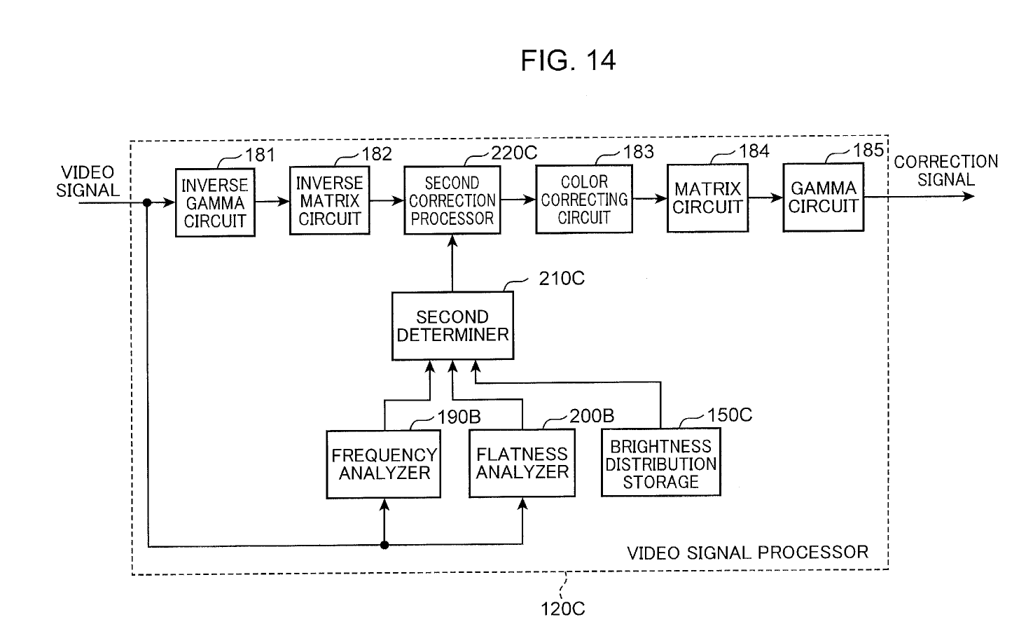

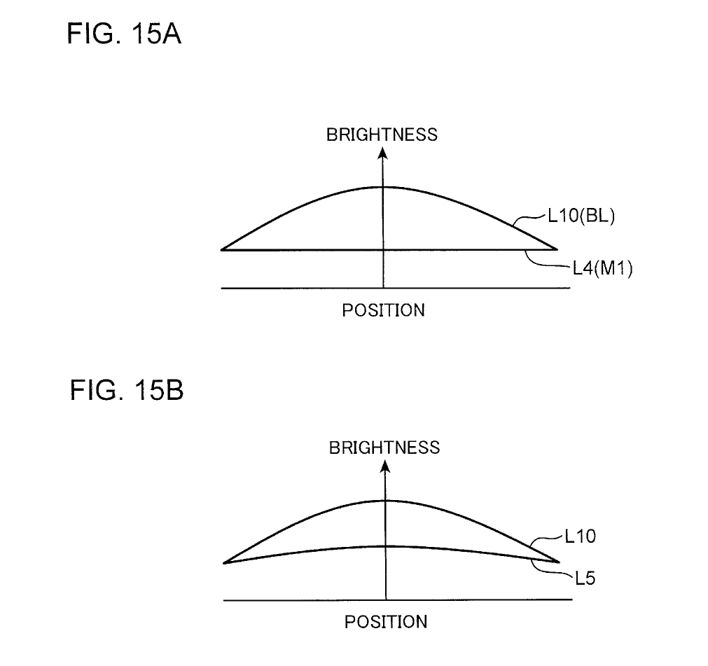

FIG. 14 is a block diagram depicting a configuration of a video signal processor disposed in a liquid crystal display device according to the fourth embodiment of the present invention. FIGS. 15A and 15B are schematic diagrams depicting examples of target brightness distribution. In the fourth embodiment, a composing element the same as the first to third embodiments is denoted with a same reference symbol. Now the liquid crystal display device according to the fourth embodiment of the present invention will be described focusing on the differences from the first to third embodiments.

The liquid crystal display device according to the fourth embodiment includes a video signal processor 120C, instead of the video signal processor 120B of the third embodiment. The video signal processor 120C includes a brightness distribution storage 150C, instead of the brightness distribution storage 150B of the video signal processor 120B of the third embodiment, includes a second determiner 210C instead of the first determiner 160B, and includes a second correction processor 220C instead of the first correction processor 180B. The video signal processor 120C does not include the function storage 170B which is included in the video signal processor 120B of the third embodiment.

The brightness distribution storage 150C stores information on current brightness distribution and target brightness distribution. The current brightness distribution stored in the brightness distribution storage 150C is the same as the current brightness distribution stored in the brightness distribution storage 150B of the third embodiment. In other words, the current brightness distribution is the brightness distribution that is on the display screen of the liquid crystal panel 111 when the backlight 112 is turned on and the transmittance of the liquid crystal of each pixel on the liquid crystal panel 111 is set to 100%. The brightness distribution storage 150C stores two-dimensional brightness distribution information as the current brightness distribution L10, as illustrated in FIG. 3 for example. The current brightness distribution depends on the emission brightness characteristics of the backlight 112.

When a guiding plate or a diffuser is disposed, the current brightness distribution depends not only on the emission brightness characteristics of the backlight 112, but also on optical characteristics of the light guiding plate or the diffuser. As illustrated in FIG. 3, in the current brightness distribution L10, the brightness is normally highest in the center portion of the display screen of the liquid crystal panel 111, then the brightness decreases in an area closer to the edge, and the brightness reaches the lowest at the four corners.

The target brightness distribution is brightness distribution that is targeted on the display screen of the liquid crystal panel 111 when the backlight 112 is turned on and the transmittance of the liquid crystal of each pixel of the liquid crystal panel 111 is set to 100%. According to the fourth embodiment, the target brightness distribution is set such that the inclination of the brightness change, with respect to the position change, is gentler than the current brightness distribution, and the brightness values are not more than those of the current brightness distribution in a part or all of the areas. According to the fourth embodiment, the target brightness distribution L4 is set to flat brightness distribution in which brightness does not change depending on the position, as illustrated in FIG. 15A.

The target brightness distribution is not limited to the flat brightness distribution as illustrated in FIG. 15A. Alternatively, the brightness distribution having a gentle inclination may be set for the target brightness distribution L1, as illustrated in FIG. 15B, for example. However, as described above, the inclination of the target brightness distribution L1 is gentler than the current brightness distribution L10. The brightness distribution is two-dimensional distribution, as illustrated in FIG. 3, but in FIG. 15A and FIG. 15B, the brightness distribution is illustrated one- dimensionally to simplify description.

In this fourth embodiment, the brightness distribution storage 150C stores the target brightness distribution L4 and the current brightness distribution L10, but an embodiment is not limited to this. Alternatively, the brightness distribution storage 150C may store information on the difference between the target brightness distribution L4 and the current brightness distribution L10.

The video signal processor 120C suppresses the brightness data of the video signal based on the brightness distribution information stored in the brightness distribution storage 150C and a required corrective suppression amount, so that the image that is displayed when the liquid crystal panel 111 is illuminated by the target brightness distribution is implemented. By this processing, the image may be displayed on the display portion 110 so that the emission brightness distribution of the liquid crystal panel 111 becomes similar to the target brightness distribution.

The second determiner 210C determines a brightness suppression parameter for corrective suppression for brightness based on the calculation results by the frequency analyzer 190B and the flatness analyzer 200B. The second correction processor 220C suppresses the input Y (brightness) data for each pixel based on the brightness suppression parameter calculated by the second determiner 210C. In this embodiment, the frequency analyzer 190B and the flatness analyzer 200B correspond to examples of the feature amount calculator, and the second determiner 210C and the second correction processor 220C correspond to an example of the brightness suppressing processor. In this embodiment, the frequency analyzer 190B corresponds to an example of the frequency calculator, and the flatness analyzer 200B corresponds to an example of the flatness calculator.

The second determiner 210C uses the analysis result by the frequency analyzer 190B, just like the first determiner 160B according to the third embodiment. In other words, when the calculation result (accumulated value of brightness components included in the filtering result) by the frequency analyzer 190B is low, the difference between the target brightness distribution L4 and the current brightness distribution L10 (FIG. 15A) does not disappear in the image to be noticeable. Hence, the second determiner 210C judges that the required corrective suppression amount is large. Based on the calculation result by the frequency analyzer 190B, the second determiner 210C calculates the required corrective suppression amount P41 in terms of the frequency as a numeric value in a 0≦P41≦255 range.

The second determiner 210C uses the analysis result by the flatness analyzer 200B, just like the first determiner 160B according to the third embodiment. In other words, when the degree of certainty of flatness of the display brightness data of the video signal that is calculated by the flatness analyzer 200B is high, the difference between the target brightness distribution L4 and the current brightness distribution L10 (FIG. 15A) is noticeable. Hence, the second determiner 210C judges that the required corrective suppression amount is large. On the other hand, when the degree of certainty of flatness calculated by the flatness analyzer 200B is low, the difference between the target brightness distribution L4 and the current brightness distribution L10 (FIG. 15A) is noticeable. Hence, the second determiner 210C judges that the required corrective suppression amount is small. Based on the degree of certainty of flatness calculated by the flatness analyzer 200B, the second determiner 210C calculates the required corrective suppression amount P42 in terms of the degree of certainty of flatness as a numeric value in a 0≦P24≦255 range.

The second determiner 210C calculates the corrective suppression amount P43 combining the required corrective suppression amount P41 and the required corrective suppression amount P42 by P43=P41×P42/256. In other words, the second determiner 210C quantitatively calculates the corrective suppression amount P43 as a numeric value in a 0≦P43≦255 range. Further, the second determiner 210C normalizes the corrective suppression amount P43 with the maximum value as 1 to determine the brightness suppression parameter β as a value in 0≦β≦1.

Based on the brightness suppression parameter β determined by the second determiner 210C, the second correction processor 220C makes corrective suppression for the display brightness data of the pixel corresponding to the position where brightness in the current brightness distribution is higher than that of the target brightness distribution in the input Y (brightness) data. An example of the processing by the second correction processor 220 will be described with reference to FIG. 15A. In FIG. 15A, BL denotes a brightness value of the current brightness distribution L10, and M1 denotes a brightness value of the target brightness distribution L4.

The correction signal Ydn after the brightness is suppressed is given by

Ydn=Ybf×{1−(1−M1/BL)×β} (Expression 2),

where Ybf denotes Y (brightness) data input to the second correction processor 220C. For example, if M1/BL=0.7 and β=0.5, then Ydn=Ybf×0.85. This means that suppression to M1/BL=0.7 is required in order for the brightness distribution to match with the target brightness distribution L4. However the degree of suppression is controlled by the brightness suppression parameter β.

In the fourth embodiment, a color correcting circuit 183 is included, just like the first embodiment. The color correcting circuit 183 calculates the input-output gain, where input is the input image brightness of the second correction processor 220C, and output is the output image brightness of the second correction processor 220C, and multiplies the Cb and Cr data by this gain.

Thus, in this fourth embodiment, the second determiner 210C calculates the required corrective suppression amount using the analysis results by the frequency analyzer 190B and the flatness analyzer 200B, and makes corrective suppression for the brightness considering the required corrective suppression amount. In other words, corrective suppression for brightness is performed in a range where side effects are not generated in this fourth embodiment. As a result, an excessive decrease in brightness is prevented and high quality images may be displayed by approximating the emission brightness distribution of the liquid crystal panel 111 from the current brightness distribution to the target brightness distribution.

In this fourth embodiment, the second determiner 210C sets the brightness suppression parameter β to a same value for the entire screen. Thereby boundaries which are visually recognized when the brightness suppression parameter β is set for each of the divided areas may be prevented.

(Others)

In the above first to fourth embodiments, the input video signal is converted into Y, Cb and Cr data. However the video signal needs not always be converted into Y, Cb and Cr data, and the inverse matrix circuit 182 and the matrix circuit 184 may be omitted. Alternatively, V (luminosity) data, which is the maximum value of the R, G or B signal of each pixel, may be used instead of Y (brightness) data. In this case, V data (=one of R, G and B) is input to the color correcting circuit 183, instead of the Y data, and two data out of the R, G and B data, which have no maximum value, are input thereto instead of the Cb and Cr data. The R, G and B signals output from the color correcting circuit 183 are converted into final correction signals by the gamma circuit 185, and are input to the liquid crystal driver 122.

Alternatively in the above second embodiment, the brightness analyzer 140 may calculate APL, which indicates the average brightness of the video signal, for each of the divided areas (FIG. 5), weight the APL, for each of the divided areas, according to the difference between the brightness distribution after the brightness corrective increase processing by the first correction processor 180 and the second target brightness distribution, and accumulate each weighted APL. When the weighted APL is large, that is, when the white area or a high brightness area is large, a slight decrease in brightness is unnoticeable. Therefore, when the weighted APL is large, the brightness suppression parameter may be increased.

In each of the above embodiments, the liquid crystal display having a backlight is described, but the present invention is not limited to this. Alternatively, a self-emitting display device, such as a plasma display device including a plasma display panel or an organic EL display device including an organic EL panel, may be used. For dispersion of self-emitting elements of a plasma display device or an organic EL display device as well, image quality may be improved by correcting the video signal according to each of the above embodiments.

The above-described embodiments primarily include aspects of the invention having the following configuration.

According to one general aspect, a display device comprising: a display portion which includes an emitting portion having one or plural light sources emitting light, and uses light emitted from the one or plural light sources of the emitting portion to display an image corresponding to a video signal including display brightness data that is set for each of plural pixels; a brightness distribution storage that stores brightness distribution information indicating emission brightness distribution of the display portion and predetermined target brightness distribution of the display portion; a first feature amount calculator that calculates a first feature amount of the image for judging an allowable corrective increase amount from the video signal for the plural pixels, the allowable corrective increase amount being an amount within which the display brightness data is subjected to corrective increase without deteriorating the image; a brightness increase processor that makes corrective increase for the display brightness data of the pixels, based on the brightness distribution information stored in the brightness distribution storage and the first feature amount calculated by the first feature amount calculator, wherein the brightness increase processor judges the allowable corrective increase amount of the display brightness of each of the pixels based on the first feature amount calculated by the first feature amount calculator, and makes corrective increase for the display brightness data of the pixels corresponding to a low brightness area where the emission brightness distribution of the display portion is lower than the target brightness distribution, based on the allowable corrective increase amount.

According to this configuration, the display portion includes the emitting portion having one or plural light sources emitting light, and uses light emitted from the one or plural light sources of the emitting portion to display an image corresponding to a video signal including display brightness data that is set for each of plural pixels. The brightness distribution storage stores brightness distribution information indicating emission brightness distribution of the display portion and predetermined target brightness distribution of the display portion. The first feature amount calculator calculates a first feature amount of the image for judging an allowable corrective increase amount from the video signal for the plural pixels, the allowable corrective increase amount being an amount within which the display brightness data is subjected to corrective increase without deteriorating the image. The brightness increase processor makes corrective increase for the display brightness data of the pixels, based on the brightness distribution information stored in the brightness distribution storage and the first feature amount calculated by the first feature amount calculator. The brightness increase processor judges the allowable corrective increase amount of the display brightness of each of the pixels based on the first feature amount calculated by the first feature amount calculator. The brightness increase processor makes corrective increase for the display brightness data of the pixels corresponding to a low brightness area where the emission brightness distribution of the display portion is lower than the target brightness distribution, based on the allowable corrective increase amount. Therefore, an image that is displayed when the emission brightness distribution of the display portion has the target brightness distribution may be implemented without deteriorating the image.

According to the above aspect of the display device, the first feature amount calculator includes a brightness data calculator that calculates the display brightness data as the first feature amount for each of the pixels included in the low brightness area where the emission brightness distribution of the display portion is lower than the target brightness distribution, and the brightness increase processor judges that the allowable corrective increase amount of the display brightness of each of the pixels decreases as a level of the display brightness data calculated by the brightness data calculator increases.

According to this configuration, the first feature amount calculator includes a brightness data calculator. The brightness data calculator calculates the display brightness data as the first feature amount for each of the pixels included in the low brightness area where the emission brightness distribution of the display portion is lower than the target brightness distribution. The brightness increase processor judges that the allowable corrective increase amount of the display brightness of each of the pixels decreases as a level of the display brightness data calculated by the brightness data calculator increases. Since the display brightness data cannot exceed the maximum value of this data, it may be determined that the allowable corrective increase amount of the display brightness of each of the pixels decreases as the level of the display brightness data increases, thereby an appropriate level of the allowable corrective increase amount may be determined.

According to the above aspect of the display device, the first feature amount calculator includes a color data calculator that calculates a saturation degree of a color indicated by the video signal as the first feature amount for each of the pixels included in the low brightness area where the emission brightness distribution of the display portion is lower than the target brightness distribution, and the brightness increase processor judges that the allowable corrective increase amount of the display brightness of each of the pixels decreases as the saturation degree of the color calculated by the color data calculator increases.

According to this configuration, the first feature amount calculator includes a color data calculator. The color data calculator calculates a saturation degree of a color indicated by the video signal as the first feature amount for each of the pixels included in the low brightness area where the emission brightness distribution of the display portion is lower than the target brightness distribution. The brightness increase processor judges that the allowable corrective increase amount of the display brightness of each of the pixels decreases as the saturation degree of the color calculated by the color data calculator increases. As the saturation degree of the color increases, it becomes more probable that the color becomes different when the display brightness is subjected to corrective increase and the image deteriorates. Therefore, as the saturation degree of the color increases, it is judged that the allowable corrective increase amount of the display brightness of each of the pixels decreases, which makes it possible to judge the allowable corrective increase amount of an appropriate level.

According to the above aspect of the display device, the display device further comprises a second feature amount calculator that calculates a second feature amount of the image for judging a required correction amount from the video signal for the plural pixels, the required correction amount indicating a degree how much the display brightness of the pixels is required to be corrected, wherein the brightness increase processor judges the required correction amount of the display brightness of each of the pixels, based on the second feature amount calculated by the second feature amount calculator, and makes corrective increase for the display brightness data based on the allowable corrective increase amount and the required correction amount, of the pixels corresponding to the low brightness area.

According to this configuration, the second feature amount calculator calculates a second feature amount of the image for judging a required correction amount from the video signal for the plural pixels, the required correction amount indicating a degree how much the display brightness of the pixels is required to be corrected. The brightness increase processor judges the required correction amount of the display brightness of each of the pixels, based on the second feature amount calculated by the second feature amount calculator. The brightness increase processor makes corrective increase for the display brightness data based on the allowable corrective increase amount and the required correction amount, of the pixels corresponding to the low brightness area. Since not only the allowable corrective increase amount but also the required correction amount is considered, the display brightness data of the pixel corresponding to the low brightness area may be correctively increased more appropriately.

According to the above aspect of the display device, the second feature amount calculator includes a frequency calculator that calculates an accumulated value as the second feature amount, the accumulated value being obtained by accumulating brightness components in a predetermined frequency range of the display brightness data of the video signal, and the brightness increase processor judges that the required correction amount decreases as the accumulated value calculated by the frequency calculator increases.

According to this configuration, the second feature amount calculator includes a frequency calculator. The frequency calculator calculates an accumulated value as the second feature amount, the accumulated value being obtained by accumulating brightness components in a predetermined frequency range of the display brightness data of the video signal. The brightness increase processor judges that the required correction amount decreases as the accumulated value calculated by the frequency calculator increases. When the accumulated value of the brightness components in the predetermined frequency range of the display brightness data of the video signal increases, the difference between the emission brightness distribution of the display portion and the target brightness distribution is unnoticeable. Therefore, the display brightness data corresponding to the low brightness area may be correctively increased more appropriately by determining that the required correction amount decreases as the accumulated value increases.

According to the above aspect of the display device, the frequency calculator sets a lower limit value and an upper limit value based on a change degree of a difference between the emission brightness distribution of the display portion and the target brightness distribution, filters the display brightness data of the video signal in a frequency range from the lower limit value to the upper limit value, and calculates an accumulated value as the second feature amount, the accumulated value being obtained by accumulating brightness components included after the filtering.

According to this configuration, the frequency calculator sets a lower limit value and an upper limit value based on a change degree of a difference between the emission brightness distribution of the display portion and the target brightness distribution, filters the display brightness data of the video signal in a frequency range from the lower limit value to the upper limit value, and calculates an accumulated value as the second feature amount, the accumulated value being obtained by accumulating brightness components included after the filtering. Since the lower limit value and the upper limit value are set based on the change degree of the difference between the emission brightness distribution of the emitting portion and the target brightness distribution, the required correction amount may be appropriately determined

According to the above aspect of the display device, the second feature amount calculator includes a flatness calculator that calculates a degree of certainty of flatness of the display brightness data of the video signal as the second feature amount, and the brightness increase processor judges that the required correction amount increases as the degree of certainty of flatness calculated by the flatness calculator increases.

According to this configuration, the second feature amount calculator includes a flatness calculator. The flatness calculator calculates a degree of certainty of flatness of the display brightness data of the video signal as the second feature amount. The brightness increase processor judges that the required correction amount increases as the degree of certainty of flatness calculated by the flatness calculator increases. The difference between the emission brightness distribution of the display portion and the target brightness distribution is noticeable more as the degree of certainty of flatness of the display brightness data of the video signal increases. Hence, by judging that the required correction amount increases as the degree of certainty of flatness increases, it becomes possible to more appropriately perform corrective increase for the display brightness data of the pixels corresponding to the low brightness area.

According to the above aspect of the display device, the flatness calculator calculates a brightness histogram indicating pixel counts every divided ranges not less than three, based on the display brightness data of the video signal, and calculates the degree of certainty of flatness based on a highest pixel count among the pixel counts of the divided ranges.

According to this configuration, the flatness calculator calculates a brightness histogram indicating pixel counts every divided ranges not less than three, based on the display brightness data of the video signal, and calculates the degree of certainty of flatness based on a highest pixel count among the pixel counts of the divided ranges. Therefore, the degree of certainty of flatness may be calculated by a simple calculation.

According to the above aspect of the display device, the brightness increase processor includes: a function data storage that stores data indicating a weakly increasing function used for increasing and decreasing a brightness corrective increase amount in response to an increase and decrease of a parameter; and a parameter determiner that determines a set value of the parameter based on the first feature amount calculated by the first feature amount calculator and the second feature amount calculated by the second feature amount calculator, and the brightness increase processor makes corrective increase for the display brightness data of the pixels corresponding to the low brightness area, based on the set value of the parameter determined by the parameter determiner and the data indicating the weakly increasing function stored in the function data storage.

According to this configuration, the brightness increase processor has a function data storage and a parameter determiner. The function data storage stores data indicating a weakly increasing function used for increasing and decreasing a brightness corrective increase amount in response to an increase and decrease of a parameter. The parameter determiner determines a set value of the parameter based on the first feature amount calculated by the first feature amount calculator and the second feature amount calculated by the second feature amount calculator. The brightness increase processor makes corrective increase for the display brightness data of the pixels corresponding to the low brightness area, based on the set value of the parameter determined by the parameter determiner and the data indicating the weakly increasing function stored in the function data storage. Therefore, the display brightness data of the pixels may be correctively increased using a simple configuration.

According to the above aspect of the display device, the display device further comprises a brightness suppressing processor that sets second target brightness distribution having brightness values not exceeding the target brightness distribution and having a shape similar to that of the target brightness distribution, and makes corrective suppression for the display brightness data of the pixels, based on the second target brightness distribution, the first feature amount calculated by the first feature amount calculator, and the second feature amount calculated by the second feature amount calculator.

According to this configuration, the brightness suppressing processor sets second target brightness distribution having brightness values not exceeding the target brightness distribution and having a shape similar to that of the target brightness distribution. The brightness suppressing processor makes corrective suppression for the display brightness data of the pixels, based on the second target brightness distribution, the first feature amount calculated by the first feature amount calculator, and the second feature amount calculated by the second feature amount calculator. Since the display brightness data of the pixels is subjected to corrective decrease based on the second target brightness distribution, the first feature amount, and the second feature amount, the display brightness data of the pixels may be correctively decreased to an appropriate level.

According to another general aspect, a display device comprising: a display portion that includes an emitting portion having one or plural light sources emitting light, and uses light emitted from the one or plural light sources of the emitting portion to display an image corresponding to a video signal including display brightness data which is set for each of plural pixels; a brightness distribution storage that stores brightness distribution information indicating emission brightness distribution of the display portion and predetermined target brightness distribution of the display portion; a feature amount calculator that calculates a feature amount of the image for judging a required corrective suppression amount from the video signal for the plural pixels, the required corrective suppression amount indicating a degree how much the display brightness of the pixels is required for corrective suppression; and a brightness suppressing processor that makes corrective suppression for the display brightness data of the pixels, based on the brightness distribution information stored in the brightness distribution storage and the feature amount calculated by the feature amount calculator, wherein the target brightness distribution is set so as to include an area having lower brightness values than emission brightness distribution of the emitting portion, and the brightness suppressing processor judges the required corrective suppression amount of the display brightness of each of the pixels, based on the feature amount calculated by the feature amount calculator, and makes corrective suppression for the display brightness data of the pixels corresponding to a high brightness area where the emission brightness distribution of the display portion is higher than the target brightness distribution, based on the required corrective suppression amount.

According to this configuration, the display portion includes the emitting portion having one or plural light sources emitting light, and uses light emitted from the one or plural light sources of the emitting portion to display an image corresponding to a video signal including display brightness data which is set for each of plural pixels. The brightness distribution storage stores brightness distribution information indicating emission brightness distribution of the display portion and predetermined target brightness distribution of the display portion. The feature amount calculator calculates a feature amount of the image for judging a required corrective suppression amount from the video signal for the plural pixels, the required corrective suppression amount indicating a degree how much the display brightness of the pixels is required for corrective suppression. The brightness suppressing processor makes corrective suppression for the display brightness data of the pixels, based on the brightness distribution information stored in the brightness distribution storage and the feature amount calculated by the feature amount calculator. The target brightness distribution is set so as to include an area having lower brightness values than emission brightness distribution of the emitting portion. The brightness suppressing processor judges the required corrective suppression amount of the display brightness of each of the pixels, based on the feature amount calculated by the feature amount calculator, and makes corrective suppression for the display brightness data of the pixels corresponding to a high brightness area where the emission brightness distribution of the display portion is higher than the target brightness distribution, based on the required corrective suppression amount. Therefore, influence by the difference between the emission brightness distribution of the display portion and the target brightness distribution may be suppressed, and an image, which is displayed when the emission brightness distribution of the display portion has the target brightness distribution, may be displayed on the display portion.

According to the above aspect of the display device, the feature amount calculator includes a frequency calculator that calculates an accumulated value as the feature amount, the accumulated value being obtained by accumulating brightness components in a predetermined frequency range of the display brightness data of the video signal, and the brightness suppressing processor judges that the required corrective suppression amount decreases as the accumulated value calculated by the frequency calculator increases.

According to this configuration, the feature amount calculator includes a frequency calculator. The frequency calculator calculates an accumulated value as the feature amount, the accumulated value being obtained by accumulating brightness components in a predetermined frequency range of the display brightness data of the video signal. The brightness suppressing processor judges that the required corrective suppression amount decreases as the accumulated value calculated by the frequency calculator increases. When the accumulated value of the brightness components in the predetermined frequency range of the display brightness data of the video signal increases, the difference between the emission brightness distribution of the display portion and the target brightness distribution is unnoticeable. Therefore, the display brightness data corresponding to the high brightness area may be correctively suppressed more appropriately by judging that the required corrective suppression amount decreases as the accumulated value increases.

According to the above aspect of the display device, the frequency calculator sets a lower limit value and an upper limit value based on a change degree of a difference between the emission brightness distribution of the display portion and the target brightness distribution, filters the display brightness data of the video signal in a frequency range from the lower limit value to the upper limit value, and calculates an accumulated value as the feature amount, the accumulated value being obtained by accumulating brightness components included after the filtering.

According to this configuration, the frequency calculator sets a lower limit value and an upper limit value based on a change degree of a difference between the emission brightness distribution of the display portion and the target brightness distribution, filters the display brightness data of the video signal in a frequency range from the lower limit value to the upper limit value, and calculates an accumulated value as the feature amount, the accumulated value being obtained by accumulating brightness components included after the filtering. Since the lower limit value and the upper limit value are set based on the change degree of the difference between the emission brightness distribution of the display portion and the target brightness distribution, the required correction amount may be appropriately judged.

According to the above aspect of the display device, the feature amount calculator includes a flatness calculator that calculates a degree of certainty of flatness of the display brightness data of the video signal as the feature amount, and the brightness suppressing processor judges that the required corrective suppression amount increases as the degree of certainty of flatness calculated by the flatness calculator increases.

According to this configuration, the feature amount calculator includes a flatness calculator. The flatness calculator calculates a degree of certainty of flatness of the display brightness data of the video signal as the feature amount. The brightness suppressing processor judges that the required corrective suppression amount increases as the degree of certainty of flatness calculated by the flatness calculator increases. The difference between the emission brightness distribution of the display portion and the target brightness distribution is noticeable more as the degree of certainty of flatness of the display brightness data of the video signal increases. Hence, by judging that the required corrective suppression amount increases as the degree of certainty of flatness of the display brightness data of the video signal increases, the display brightness data of the pixels corresponding to the high brightness area may be correctively suppressed more appropriately.

According to the above aspect of the display device, the flatness calculator calculates a brightness histogram indicating pixel counts every divided ranges not less than three, based on the display brightness data of the video signal, and calculates the degree of certainty of flatness based on a highest pixel count among the pixel counts of the divided ranges.

According to this configuration, the flatness calculator calculates a brightness histogram indicating pixel counts every divided ranges not less than three, based on the display brightness data of the video signal, and calculates the degree of certainty of flatness based on a highest pixel count among the pixel counts of the divided ranges. Therefore, the degree of certainty of flatness may be calculated by a simple calculation.

According to another general aspect, a display device comprising: a display portion that includes an emitting portion having one or plural light sources emitting light, and uses light emitted from the one or plural light sources of the emitting portion to display an image corresponding to a video signal including display brightness data which is set for each of plural pixels; a brightness distribution storage that stores brightness distribution information indicating emission brightness distribution of the display portion and desired target brightness distribution of the display portion; a feature amount calculator that calculates a feature amount of the image for judging a required corrective increase amount from the video signal for the plural pixels, the required corrective increase amount indicating a degree how much the display brightness of the pixels is required for corrective increase; and a brightness increase processor that makes corrective increase for the display brightness data of the pixels, based on the brightness distribution information stored in the brightness distribution storage and the feature amount calculated by the feature amount calculator, wherein the target brightness distribution is set so as to include an area having higher brightness values than emission brightness distribution of the emitting portion, and the brightness increase processor judges the required corrective increase amount of the display brightness of each of the pixels, based on the feature amount calculated by the feature amount calculator, and makes corrective increase for the display brightness data of the pixels corresponding to a low brightness area where the emission brightness distribution of the display portion is lower than the target brightness distribution, based on the required corrective increase amount.

According to this configuration, the display portion includes the emitting portion having one or plural light sources emitting light, and uses light emitted from the one or plural light sources of the emitting portion to display an image corresponding to a video signal including display brightness data which is set for each of plural pixels. The brightness distribution storage stores brightness distribution information indicating emission brightness distribution of the display portion and predetermined target brightness distribution of the display portion. The feature amount calculator calculates a feature amount of the image for judging a required corrective increase amount from the video signal for the plural pixels, the required corrective increase amount indicating a degree how much the display brightness of the pixels is required for corrective increase. The brightness increase processor makes corrective increase for the display brightness data of the pixels, based on the brightness distribution information stored in the brightness distribution storage and the feature amount calculated by the feature amount calculator. The target brightness distribution is set so as to include an area having higher brightness values than emission brightness distribution of the emitting portion. The brightness increase processor judges the required corrective increase amount of the display brightness of each of the pixels, based on the feature amount calculated by the feature amount calculator, and makes corrective increase for the display brightness data of the pixels corresponding to a low brightness area where the emission brightness distribution of the display portion is lower than the target brightness distribution, based on the required corrective increase amount. Therefore, influence by the difference between the emission brightness distribution of the display portion and the target brightness distribution may be suppressed, and an image, which is displayed when the emission brightness distribution of the display portion has the target brightness distribution, may be displayed on the display portion.

According to the above aspect of the display device, the feature amount calculator includes a frequency calculator that calculates an accumulated value as the feature amount, the accumulated value being obtained by accumulating brightness components in a predetermined frequency range of the display brightness data of the video signal, and the brightness increase processor judges that the required corrective increase amount decreases as the accumulated value calculated by the frequency calculator increases.

According to this configuration, the feature amount calculator includes a frequency calculator. The frequency calculator calculates an accumulated value as the feature amount, the accumulated value being obtained by accumulating brightness components in a predetermined frequency range of the display brightness data of the video signal. The brightness increase processor judges that the required corrective increase amount decreases as the accumulated value calculated by the frequency calculator increases. When the accumulated value of the brightness components in the predetermined frequency range of the display brightness data of the video signal increases, the difference between the emission brightness distribution of the display portion and the target brightness distribution is unnoticeable. Therefore, the display brightness data of the pixel corresponding to the low brightness area may be correctively increased more appropriately by judging that the required corrective increase amount decreases as the accumulated value increases.

According to the above aspect of the display device, the frequency calculator sets a lower limit value and an upper limit value based on a change degree of a difference between the emission brightness distribution of the display portion and the target brightness distribution, filters the display brightness data of the video signal in a frequency range from the lower limit value to the upper limit value, and calculates an accumulated value as the feature amount, the accumulated value being obtained by accumulating brightness components included after the filtering.

According to this configuration, the frequency calculator sets a lower limit value and an upper limit value based on a change degree of a difference between the emission brightness distribution of the display portion and the target brightness distribution, filters the display brightness data of the video signal in a frequency range from the lower limit value to the upper limit value, and calculates an accumulated value as the feature amount, the accumulated value being obtained by accumulating brightness components included after the filtering. Since the lower limit value and the upper limit value are set based on the change degree of the difference between the emission brightness distribution of the display portion and the target brightness distribution, the required correction amount may be appropriately judged.

According to the above aspect of the display device, the feature amount calculator includes a flatness calculator that calculates a degree of certainty of flatness of the display brightness data of the video signal as the feature amount, and the brightness increase processor judges that the required corrective increase amount increases as the degree of certainty of flatness calculated by the flatness calculator increases.

According to this configuration, the feature amount calculator includes a flatness calculator. The flatness calculator calculates a degree of certainty of flatness of the display brightness data of the video signal as the feature amount. The brightness increase processor judges that the required corrective increase amount increases as the degree of certainty of flatness calculated by the flatness calculator increases. The difference between the emission brightness distribution of the display portion and the target brightness distribution is noticeable more as the degree of certainty of flatness of the display brightness data of the video signal increases. Hence, by judging that the required corrective increase amount increases as the degree of certainty of flatness of the display brightness data of the video signal increases, the display brightness data of the pixel corresponding to the low brightness area may be correctively increased more appropriately.

According to the above aspect of the display device, the flatness calculator calculates a brightness histogram indicating pixel counts every divided ranges not less than three, based on the display brightness data of the video signal, and calculates the degree of certainty of flatness based on a highest pixel count among the pixel counts of the divided ranges.

According to this configuration, the flatness calculator calculates a brightness histogram indicating pixel counts every divided ranges not less than three, based on the display brightness data of the video signal, and calculates the degree of certainty of flatness based on a highest pixel count among the pixel counts of the divided ranges. Therefore, the degree of certainty of flatness may be calculated by a simple calculation.

### INDUSTRIAL APPLICABILITY

A display device is useful that may prevent from degrading quality of a displayed image by appropriately correcting the brightness in response to the input video signal, in a display device that includes a display portion which has an emitting portion having one or plural light sources emitting light, and displays an image corresponding to a video signal.

1. A display device comprising:
a display portion which includes an emitting portion having one or plural light sources emitting light, and uses light emitted from the one or plural light sources of the emitting portion to display an image corresponding to a video signal including display brightness data that is set for each of plural pixels;
a brightness distribution storage that stores brightness distribution information indicating emission brightness distribution of the display portion and predetermined target brightness distribution of the display portion;
a first feature amount calculator that calculates a first feature amount of the image for judging an allowable corrective increase amount from the video signal for the plural pixels, the allowable corrective increase amount being an amount within which the display brightness data is subjected to corrective increase without deteriorating the image;
a brightness increase processor that makes corrective increase for the display brightness data of the pixels, based on the brightness distribution information stored in the brightness distribution storage and the first feature amount calculated by the first feature amount calculator, wherein
the brightness increase processor judges the allowable corrective increase amount of the display brightness of each of the pixels based on the first feature amount calculated by the first feature amount calculator, and makes corrective increase for the display brightness data of the pixels corresponding to a low brightness area where the emission brightness distribution of the display portion is lower than the target brightness distribution, based on the allowable corrective increase amount.

2. The display device according to claim 1, wherein
the first feature amount calculator includes a brightness data calculator that calculates the display brightness data as the first feature amount for each of the pixels included in the low brightness area where the emission brightness distribution of the display portion is lower than the target brightness distribution, and
the brightness increase processor judges that the allowable corrective increase amount of the display brightness of each of the pixels decreases as a level of the display brightness data calculated by the brightness data calculator increases.

3. The display device according to claim 1, wherein
the first feature amount calculator includes a color data calculator that calculates a saturation degree of a color indicated by the video signal as the first feature amount for each of the pixels included in the low brightness area where the emission brightness distribution of the display portion is lower than the target brightness distribution, and
the brightness increase processor judges that the allowable corrective increase amount of the display brightness of each of the pixels decreases as the saturation degree of the color calculated by the color data calculator increases.

4. The display device according to claim 1, further comprising a second feature amount calculator that calculates a second feature amount of the image for judging a required correction amount from the video signal for the plural pixels, the required correction amount indicating a degree how much the display brightness of the pixels is required to be corrected, wherein
the brightness increase processor judges the required correction amount of the display brightness of each of the pixels, based on the second feature amount calculated by the second feature amount calculator, and makes corrective increase for the display brightness data based on the allowable corrective increase amount and the required correction amount, of the pixels corresponding to the low brightness area.

5. The display device according to claim 4, wherein
the second feature amount calculator includes a frequency calculator that calculates an accumulated value as the second feature amount, the accumulated value being obtained by accumulating brightness components in a predetermined frequency range of the display brightness data of the video signal, and
the brightness increase processor judges that the required correction amount decreases as the accumulated value calculated by the frequency calculator increases.

6. The display device according to claim 5, wherein
the frequency calculator sets a lower limit value and an upper limit value based on a change degree of a difference between the emission brightness distribution of the display portion and the target brightness distribution, filters the display brightness data of the video signal in a frequency range from the lower limit value to the upper limit value, and calculates an accumulated value as the second feature amount, the accumulated value being obtained by accumulating brightness components included after the filtering.

7. The display device according to claim 4, wherein
the second feature amount calculator includes a flatness calculator that calculates a degree of certainty of flatness of the display brightness data of the video signal as the second feature amount, and
the brightness increase processor judges that the required correction amount increases as the degree of certainty of flatness calculated by the flatness calculator increases.

8. The display device according to claim 7, wherein
the flatness calculator calculates a brightness histogram indicating pixel counts every divided ranges not less than three, based on the display brightness data of the video signal, and calculates the degree of certainty of flatness based on a highest pixel count among the pixel counts of the divided ranges.

9. The display device according to claim 4, wherein
the brightness increase processor includes:
a function data storage that stores data indicating a weakly increasing function used for increasing and decreasing a brightness corrective increase amount in response to an increase and decrease of a parameter; and
a parameter determiner that determines a set value of the parameter based on the first feature amount calculated by the first feature amount calculator and the second feature amount calculated by the second feature amount calculator, and
the brightness increase processor makes corrective increase for the display brightness data of the pixels corresponding to the low brightness area, based on the set value of the parameter determined by the parameter determiner and the data indicating the weakly increasing function stored in the function data storage.

10. The display device according to claim 4, further comprising a brightness suppressing processor that sets second target brightness distribution having brightness values not exceeding the target brightness distribution and having a shape similar to that of the target brightness distribution, and makes corrective suppression for the display brightness data of the pixels, based on the second target brightness distribution, the first feature amount calculated by the first feature amount calculator, and the second feature amount calculated by the second feature amount calculator.

11. A display device comprising:
a display portion that includes an emitting portion having one or plural light sources emitting light, and uses light emitted from the one or plural light sources of the emitting portion to display an image corresponding to a video signal including display brightness data which is set for each of plural pixels;
a brightness distribution storage that stores brightness distribution information indicating emission brightness distribution of the display portion and predetermined target brightness distribution of the display portion;
a feature amount calculator that calculates a feature amount of the image for judging a required corrective suppression amount from the video signal for the plural pixels, the required corrective suppression amount indicating a degree how much the display brightness of the pixels is required for corrective suppression; and
a brightness suppressing processor that makes corrective suppression for the display brightness data of the pixels, based on the brightness distribution information stored in the brightness distribution storage and the feature amount calculated by the feature amount calculator, wherein
the target brightness distribution is set so as to include an area having lower brightness values than the emission brightness distribution of the display portion, and
the brightness suppressing processor judges the required corrective suppression amount of the display brightness of each of the pixels, based on the feature amount calculated by the feature amount calculator, and makes corrective suppression for the display brightness data of the pixels corresponding to a high brightness area where the emission brightness distribution of the display portion is higher than the target brightness distribution, based on the required corrective suppression amount.

12. The display device according to claim 11, wherein
the feature amount calculator includes a frequency calculator that calculates an accumulated value as the feature amount, the accumulated value being obtained by accumulating brightness components in a predetermined frequency range of the display brightness data of the video signal, and
the brightness suppressing processor judges that the required corrective suppression amount decreases as the accumulated value calculated by the frequency calculator increases.

13. The display device according to claim 12, wherein
the frequency calculator sets a lower limit value and an upper limit value based on a change degree of a difference between the emission brightness distribution of the display portion and the target brightness distribution, filters the display brightness data of the video signal in a frequency range from the lower limit value to the upper limit value, and calculates an accumulated value as the feature amount, the accumulated value being obtained by accumulating brightness components included after the filtering.

14. The display device according to claim 11, wherein
the feature amount calculator includes a flatness calculator that calculates a degree of certainty of flatness of the display brightness data of the video signal as the feature amount, and
the brightness suppressing processor judges that the required corrective suppression amount increases as the degree of certainty of flatness calculated by the flatness calculator increases.

15. The display device according to claim 14, wherein
the flatness calculator calculates a brightness histogram indicating pixel counts every divided ranges not less than three, based on the display brightness data of the video signal, and calculates the degree of certainty of flatness based on a highest pixel count among the pixel counts of the divided ranges.

16. A display device comprising:
a display portion that includes an emitting portion having one or plural light sources emitting light, and uses light emitted from the one or plural light sources of the emitting portion to display an image corresponding to a video signal including display brightness data which is set for each of plural pixels;
a brightness distribution storage that stores brightness distribution information indicating emission brightness distribution of the display portion and desired target brightness distribution of the display portion;
a feature amount calculator that calculates a feature amount of the image for judging a required corrective increase amount from the video signal for the plural pixels, the required corrective increase amount indicating a degree how much the display brightness of the pixels is required for corrective increase; and
a brightness increase processor that makes corrective increase for the display brightness data of the pixels, based on the brightness distribution information stored in the brightness distribution storage and the feature amount calculated by the feature amount calculator, wherein
the target brightness distribution is set so as to include an area having higher brightness values than the emission brightness distribution of the display portion, and
the brightness increase processor judges the required corrective increase amount of the display brightness of each of the pixels, based on the feature amount calculated by the feature amount calculator, and makes corrective increase for the display brightness data of the pixels corresponding to a low brightness area where the emission brightness distribution of the display portion is lower than the target brightness distribution, based on the required corrective increase amount.

17. The display device according to claim 16, wherein
the feature amount calculator includes a frequency calculator that calculates an accumulated value as the feature amount, the accumulated value being obtained by accumulating brightness components in a predetermined frequency range of the display brightness data of the video signal, and
the brightness increase processor judges that the required corrective increase amount decreases as the accumulated value calculated by the frequency calculator increases.

18. The display device according to claim 17, wherein
the frequency calculator sets a lower limit value and an upper limit value based on a change degree of a difference between the emission brightness distribution of the display portion and the target brightness distribution, filters the display brightness data of the video signal in a frequency range from the lower limit value to the upper limit value, and calculates an accumulated value as the feature amount, the accumulated value being obtained by accumulating brightness components included after the filtering.

19. The display device according to claim 16, wherein
the feature amount calculator includes a flatness calculator that calculates a degree of certainty of flatness of the display brightness data of the video signal as the feature amount, and
the brightness increase processor judges that the required corrective increase amount increases as the degree of certainty of flatness calculated by the flatness calculator increases.

20. The display device according to claim 19, wherein
the flatness calculator calculates a brightness histogram indicating pixel counts every divided ranges not less than three, based on the display brightness data of the video signal, and calculates the degree of certainty of flatness based on a highest pixel count among the pixel counts of the divided ranges.
